(19) United States
(12) Patent Application Publication
(10) Pub. No.: US 2024/0100761 A1
(43) Pub. Date: Mar. 28, 2024

(54) MELT CONDUCTOR FOR AN EXTRUSION TOOL OF AN EXTRUSION SYSTEM, EXTRUSION TOOL, EXTRUSION SYSTEM AND METHOD FOR OPERATING AN EXTRUSION SYSTEM OF THIS TYPE

(71) Applicant: REIFENHÄUSER GMBH & CO. KG MASCHINENFABRIK, Troisdort (DE)

(72) Inventors: Helmut MEYER, Troisdorf (DE); Volkmar KRUK, Meerbusch (DE); Anna Klara ROTTSTEGGE, Köln (DE); Hans-Georg GEUS, Niederkassel (DE); Tim POHL, Köln (DE)

(21) Appl. No.: 17/768,295

(22) PCT Filed: Oct. 14, 2020
(86) PCT No.: PCT/DE2020/200086

§ 371 Date: Apr. 12, 2022

(30) Foreign Application Priority Data
Oct. 15, 2019 (DE) 10 2019 007 153.0
Jul. 10, 2020 (DE) 10 2020 118 214.7

(51) Int. Cl. B29C 48/36; B29C 48/30; B29C 48/695

(52) U.S. Cl. CPC B29C 48/362; B29C 48/30; B29C 48/695

(57) ABSTRACT

The invention relates to a melt conductor (1), in particular a melt distributor or melt mixer, for an extruding die (2) of an extrusion facility (3), comprising two or more melt conductor blocks (4a, 4b) and a multi-channel system (5), the multi-channel system (5) being arranged inside at least one of the melt conductor blocks (4a, 4b) with three-dimensional extension and having at least one input (6) and at least one output (7) for polymer melt, between one input (6) and one output (7) fluidically connected to the input (6) several branchings (8) arranged in series and several levels (9a) of sub-branches (10) being formed over several levels (12a, 12b) of divided melt channels (11a, 11b); with m melt channels (11a) of the a^{th} level (12a) with x^{th} local cross-sections and n melt channels (11b) of the b^{th} level (12b) with y^{th} local cross-sections being present, wherein n>m if b>a, the y^{th} local cross-sections of the melt channels (11b) of the b^{th} level (12b) being smaller than the x^{th} local cross-sections of the melt channels (11a) of the a^{th} level (12a). The invention further relates to an extruding die, an extrusion facility and to a method of operating the extrusion facility.

The invention relates to a melt conductor for an extruding die of an extrusion facility, having a melt conductor block with a multi-channel system.

The invention further relates to an extruding die for at least indirectly extruding or manufacturing extrusion products such as films, nonwoven fabrics, profiles, pipes, blow-molded parts, filaments, plates, semi-finished products, hoses, cables, compounds or semi-finished foam products. An extruding die generally comprises one or more melt conductors embodied as melt distributors and/or melt mixers. The extruding die is designed to distribute and/or to mix a polymer melt which is provided and fed in by at least one provision unit, and to conduct the polymer melt directly into the environment of the extruding die, depending on the embodiment of the melt conductor or melt conductors. In such case, one or more outputs of the respective melt conductor function(s) as extrusion nozzle(s) or as nozzle output(s). Alternatively, a separate extrusion nozzle can be arranged downstream of the melt conductor or melt conductors, which is fed with polymer melt by one or more melt conductor(s) and conducts the polymer melt from the extruding die to the environment, at least indirectly. In this case, that is, the extruding die comprises melt conductor(s) as well as an extrusion nozzle downstream of the designated polymer melt.

The melt conductor(s) and the extrusion nozzle can be separate components. It is also conceivable, however, for the melt conductor(s) and the extrusion nozzle to be made in one piece. That is, the extruding die can be an assembly consisting of the abovementioned components as well as other components, depending on design and requirements of the extrusion facility. The nozzle outputs of the melt conductor, or the extrusion nozzle, respectively, are therefore the components forming the extrusion product in the direction of flow of the polymer melt.

A melt mixer is a component or an assembly which receives a plasticized polymer melt in one or more inputs, with the polymer melt being subsequently combined and mixed via intersecting or combined melt channels, until the polymer melt exits from the melt mixer at one or more outputs the number of which is lower than that of the inputs. That is, the polymer melt is at first divided into a plurality of melt filaments conducted in a plurality of melt channels and combined by and by through the multi-channel system. In other words, the melt mixer has melt channels in a direction opposite to the designated direction of flow of the polymer melts, which channels are divided into at least one main branch and several levels of sub-branches. Reversely, melt channels and therefore also the melt filaments are combined in the designated direction of flow of the polymer melts by means of several levels of combination ducts, so that at an output side of the melt mixer there are fewer outputs than inputs at an input side of the melt mixer.

A melt distributor, in contrast, is a component or an assembly which receives a plasticized polymer melt in one or more inputs, the polymer melt being subsequently divided into different melt channels until the polymer melt is output at one or more outputs the number of which is larger than that of the inputs in the melt distributor. Therefore, the polymer melt is by and by divided by the multi-channel system into a plurality of melt filaments conducted in melt channels. In other words, the melt distributor has melt channels in a designated direction of flow of the polymer melt, which melt channels are divided into melt sub-channels via at least one main branch and several levels of sub-branches. Reversely, melt channels are combined via several levels of combination ducts in a direction opposite to the designated direction of flow of the polymer melt such that at an output side of the melt mixer, there are more outputs than there are inputs at an input side of the melt mixer.

The invention also relates to an extrusion facility which is embodied particularly as a cast film, meltblown, spunbond, blown-film, monofilament or multifilament line and comprises an extruding die with at least one melt conductor of the abovementioned type. The extrusion facility is substantially designed to receive an extrudable polymer, convert it into or process it as a polymer melt and then create an extrusion product by suitably conducting the polymer melt and subsequently atomizing the same.

The term “extrudable polymer” substantially designates materials, mixtures and commercial additives thereof which are extrudable, i.e. can be processed by an extruder. In particular, it designates thermoplasts, such as polyvinylchloride (PVC), polyethylene (PE), polypropylene (PP), polyamide (PA), acrylonitrile butadiene styrene copolymer (ABS) polycarbonate (PC) styrene-butadiene (SB), polymethylmethacrylate (PMMA) polyurethane (PUR) polyethyleneterephthalate (PET), polyvinylalcohol (PVOH, PVAL) or polysulfone (PSU). In particular, the polymer can be a plastic polymer. Additionally, biomaterials such as thermoplastic starch, solutions and other materials are extrudable and can be used for the present solution instead of or in combination with a plastic polymer. For simplicity, the terms “polymer” or “plastic polymer” will generally be used in the context of the present patent application.

The extrudable polymer can be provided to the extrusion facility in substantially solid form, for example as a granulate, a powder or in the form of flakes. Alternatively, it is conceivable that at least part of the extrudable polymer is available in substantially liquid form. The provision unit providing the extrudable polymer can be, for instance, a reservoir providing the polymer in the form suitable for the melt conductor so as to feed the melt conductor. Alternatively, the provision unit can be an extruder which converts the extrudable polymer in advance into a phase optimal for feeding the melt conductor, for instance from a substantially solid form into a substantially liquid form. In feeding the melt conductor, the polymer melt is normally substantially completely molten or plasticized or in solution and is subsequently divided and/or combined through the melt conductor. It is also possible that part of the polymer is present in substantially solid form or is supplemented to the substantially liquid polymer melt as an additive before feeding of the melt conductor, the solid component having a different melting temperature than molten or liquid component. In other words, the polymer in this case consists of at least two components provided to the melt conductor together or separately.

The invention further relates to a method of operating an extrusion facility.

Generic melt conductors and extrusion dies are known from the state of the art of extrusion technology and can be implemented in various embodiments.

Extrusion dies with a circular or ring gap-shaped cross-section of the extrusion nozzle are known. For instance, there are spiral mandrels for feeding circular dies with a polymer melt from a provision unit, the spiral mandrels having helical grooves provided on the outside or the inside of a lateral surface of a mandrel or a sleeve. In this connection, there are also sleeve distributors or mandrel holders by means of which the polymer melt can be distributed evenly such that a film tubing or a profile can exit from the extruding die.

Furthermore, extruding dies with a slot-shaped output cross-section of the extrusion nozzle are also known. It is the purpose of the melt conductor of such an extruding die to feed a polymer melt provided by a provision unit as evenly as possible to the nozzle outputs or the extrusion nozzle, respectively, so that a necessary amount of polymer melt is available over the desired width at each position of the nozzle output. State of the art are in particular melt conductor systems in the form of T distributors, fishtail distributors or coathanger distributors.

Extruding dies with a plurality of individual output cross-sections are known as well. It is the aim of the melt conductor of this extruding die to feed a polymer melt provided by a provision unit as evenly as possible to the nozzle outputs or the extrusion nozzle, respectively. Depending on the field of application, these melt conductors are formed as T distributors, coathanger distributors, line distributors, channel distributors, step distributors, sleeve distributors, spiral mandrels or gap distributors.

Most known melt conductors have a multi-part construction, with at least two melt conductor halves being screwed together. In addition, there are also weld structures. It is increasingly problematic that with ever increasing dimensions of the extruding dies, the dimensions of a melt conductor increase as well, causing the pressure inside the die due to shear stresses of the polymer melt and consequently the stresses on the components, particularly on the components conducting the polymer melt, to rise. This leads to limitations in construction and dimensioning in particular of the extruding die, especially if products with a small extrusion cross-section are extruded.

In any case, such melt conductors are employed to evenly distribute or combine a polymer melt provided substantially continuously from a provision unit from an input side of the melt conductor with an input overall cross-section to an output side of the melt conductor with an output overall cross-section substantially altered in terms of geometry and space with respect to the input overall cross-section.

It is therefore the task of a melt conductor in the form of a melt distributor to provide the polymer melt downstream on the output side of the melt distributor with a larger output overall cross-section than it was fed to the melt conductor upstream. In other words, the polymer melt must be evenly distributed from a first overall throughput cross-section to a second overall throughput cross-section with a larger width, where the respective output melt channel cross-section is not necessarily rectilinear, as is the case with a slit die on the output side, but can also be arc-shaped or circular, as in a circular die arranged at the output side. In any case, the overall circumference of the second overall throughput cross-section, that is, the sum of all circumferences of the melt channels at the output side of the melt conductor, is much larger than that of the first overall throughput cross-section at the input side of the melt conductor.

In contrast, the task of a melt conductor in the form of a melt mixer is to provide the polymer melt downstream on the output side of the melt distributor with a smaller output overall cross-section than it was fed to the melt conductor upstream. In other words, the polymer melt must be evenly guided and mixed from a first overall throughput cross-section to a second overall throughput cross-section with a substantially smaller overall cross-sectional area, where in this case as well, the respective output melt channel cross-section is not necessarily rectilinear.

As a rule, the polymer melt is continuously provided at the input side of the melt conductor by at least one provision unit, in particular by at least one extruder or the like, and is fed to the melt conductor. At the output side of the melt conductor, the polymer melt is at least indirectly atomized so as to continuously produce an extrusion product.

For instance, DE 21 14 465 A discloses a device for the even distribution of thermoplastics from at least one extruder head nozzle to several blow heads or pointed heads, the device having a massive distributor block in which a plurality of bore holes and additional bolts are introduced so as to implement melt ducts and deflection means within the massive distributor block.

In EP 0 197 181 B1, a method of manufacturing a composite injection molding distributor is described, the injection molding distributor having different branchings for transferring melt from a common inlet opening to a plurality of outlet openings. The injection molding distributor is composed of two plates with opposite surfaces, made of tool steel and screwed together, the surfaces having matching grooves for forming melt channels inside the melt distributor.

From DE 197 03 492 A1, a melt distributor for a plastic melt plasticized in an extruder is known, which melt is divided into several individual strands for different processing tools after having been pressed out of an extrusion nozzle. The melt distributor has a feed channel and a connected carbine with distributor channels, the number of distributor channels corresponding to the number of processing tools, and the center points of the openings of the distributor channels formed on the carbine being positioned on one circle so as to be able to provide a plastic melt with temperature profiles as equal as possible at all processing tools.

Whenever in the present patent application a “melt conductor” is mentioned, this indicates a melt conductor of an extrusion facility which either has nozzle outputs for originating extrusion products itself or is adapted for feeding a shaping extrusion nozzle. That is, a melt conductor is indicated which is part of an extruding die of an extrusion facility. The wording “for an extruding die of an extrusion facility” in the Claims is not intended to indicate that the extruding die or the facility are necessarily part of the respective Claim, but instead only suitability is disclosed. Furthermore, the wording “for an extrusion facility” is not intended to imply that the facility is compulsorily part of the respective Claim.

The invention is based on the task of further developing melt conductors and of overcoming the drawbacks thereof. In particular, the invention is based on the task of further developing extruding dies, extrusion facilities and corresponding methods, in particular for operating such extrusion facilities.

According to the invention, this task is solved by a melt conductor having the features of the independent Claim 1. Advantageous optional further developments of the melt conductor result from the dependent Claims 2 through 12. Furthermore, the object of the invention is achieved by an extruding die according to Claim 13. Advantageous further developments of the extruding die result from the dependent Claim 14. The task of the invention is further achieved by an extrusion facility according to Claim 15. In addition, the task of the invention is achieved by a method of operating a facility according to Claim 16.

In a first aspect of the present invention, this task is solved by a melt conductor, in particular a melt distributor or melt mixer, for an extruding die of an extrusion facility,
having a melt conductor block with a multi-channel system,
the multi-channel system being arranged three-dimensionally within the melt conductor block and having at least one input and at least one output for polymer melt,
where between an input and an output fluidically connected to the input, several branchings arranged behind one another and several levels of further branchings are formed over several levels of separated melt channels,
m melt channels of level a with x^{th} local cross-sections and n melt channels of level b with y^{th} local cross-sections being present,
   wherein n>m if b>a,
where the y^{th} local cross-sections of the melt channels of the b^{th} level are smaller than the x^{th} local cross-sections of the melt channels of the a^{th} level
   and where
in the designated direction of flow of the polymer melt, the melt channels of the a^{th} level are oriented toward the input and the melt channels of the b^{th} level toward the output such that the melt conductor serves a melt distributor for a designated melt stream of the polymer melt,
   or
in the designated direction of flow of the polymer melt, the melt channels of the a^{th} level are oriented toward the output and the melt channels of the b^{th} level toward the input such that the melt conductor serves a melt mixer for a designated melt stream of the polymer melt.

First, it is explicitly pointed out that within the framework of the present patent application, indefinite articles and numerals such as “one”, “two” etc. are normally to be understood as indicating a minimum, i.e. “at least one . . . ”, “at least two . . . ” etc. unless it becomes explicitly clear from the respective context or is obvious or technically indispensable for the person skilled in the art that only “exactly one . . . ”, “exactly two . . . ” etc. can be intended.

Additionally, all numerals and all information on method and/or device parameters are to be understood in the technical sense, i.e. taking into account the usual tolerances.

Even if the restrictive wordings “at least” or the like are used, this does not mean that if it simply says “one”, i.e. without the use of “at least” or the like, “exactly one” is intended.

Some terminology will be explained in the following:

A “melt conductor” is a component or an assembly comprising a melt conductor block with a multi-channel system which is adapted, depending on the embodiment of the multi-channel system, to distribute and/or combine a polymer melt fed to the melt conductor. The melt conductor can be embodied exclusively as a melt distributor distributing the designated polymer melt from at least one input on a plurality of outputs. Furthermore, the melt conductor can be embodied exclusively as a melt mixer which combines the designated polymer melt from two or more inputs to an overall number of outputs which is lower than the number of inputs. Alternatively, the melt conductor can be embodied partly as a melt distributor and partly as a melt mixer, in any order, such that the designated polymer melt can be distributed and combined as desired, with the number of in- and outputs being selectable as desired. The melt conductor is preferably at least partly manufactured by means of an additive manufacturing method.

The “melt conductor block” is the component of the melt conductor which, in combination and tensioned together with other melt conductor blocks, forms a block unit in which the multi-channel system is entirely or partly accommodated and/or which forms the multi-channel system by the joining of components of the multi-channel system which are matched in terms of their fluid lines. The respective melt conductor block is preferably formed by means of an additive manufacturing method. The respective melt conductor block can be a base body formed massive or with support structures, for instance in skeletal construction. The support structures can be formed to guarantee static stability of the melt conductor block and further to support the multi-channel system. If the melt conductor is embodied as a melt distributor, the term “melt conductor block” will be used as a synonym for the melt conductor block in the following. In an analogous manner, the term “melt mixer block” will be used as a synonym for the melt conductor block if the melt conductor is embodied as a melt mixer.

The melt conductor blocks are preferably embodied such as to form a modular melt conductor. This means that the melt conductor blocks can be basically—provided they are made to match—combined and interconnected or tensioned with each other as desired. Consequently, the individual melt conductor blocks are replaceable and arranged with respect to each other such that an easy assembly, maintenance and/or repair of the melt conductor is possible. In other words, the melt conductor blocks can be interconnected releasably, that is, for instance—and preferably—by mutual tensioning and sealing, but also non-releasably, that is in particular, firmly bonded. A releasable bonding or tensioning is intended to mean that the individual melt conductor blocks are formed such that they can be disassembled or replaced in a non-destructive manner, for instance in case of damage, for maintenance, for replacement of a module, for transport or the like. In this manner, easy assembly, disassembly, maintenance and/or repair of the melt conductor are possible.

One advantage of the modular structure of the melt conductor using several melt conductor blocks is that melt conductor blocks with a relatively simple structure can be manufactured and stored as standard blocks which may have a multi-channel system with comparatively simple channel structures and/or an outer geometry which is easy to produce. This allows an easy assembly of the melt conductor by simplification of the melt conductor blocks, where the melt conductor blocks can be arranged in series and/or in parallel, as desired, depending on the structure if the base body and/or of the multi-channel system. In addition, standard blocks can be combined as desired with melt conductor blocks structured and constructed individually which can in addition be formed such as to tightly seal channel outputs of the standard blocks. An advantageous method of constructing a melt conductor can therefore consist in joining, on the one hand, a selection of standard blocks kept in store for several different orders and, on the other hand, blocks produced individually for customization purposes.

A “melt channel” is a substantially longitudinal portion of the multi-channel system conducting a polymer melt (or a melt stream of the polymer melt) which can extend exclusively longitudinally or straight or which can have curvatures so as to achieve a three-dimensional embodiment of the multi-channel system. A plurality of such melt channels are fluidically interconnected via branchings and sub-branches which thus form the multi-channel system, where two or more melt channels can be arranged in series and/or in parallel so as to distribute and/or mix the polymer melt according to the requirements made on the melt conductor. The melt channels extend from the respective input to the respective output which is fluidically connected to the input.

The respective melt channel can be embodied as desired. It is possible, for instance, for it to have a substantially unaltered melt channel cross-section, that is a local cross-section of any shape which extends between the branchings over the entire length of the melt channel. The local cross-section can have a substantially circular cross-section, a substantially oval or elliptical cross-section and/or a substantially rectangular or square cross-section. Alternatively, a cross-sectional shape deviating from the well-known standard geometric shapes can be selected for the melt channel, in particular in transition points between the known standard shapes. Whenever within the framework of this invention a specific cross-sectional shape of a melt channel is mentioned, it is intended that the respective melt channel has this substantially constant cross-sectional shape or local cross-section over a major part of its axial extension, preferably over more than or equal to 50% of the length of the respective melt channel, preferably over at least ⅔ of the length of the channel, preferably over at least ¾ of the length of the channel.

Melt channels arranged serially behind one another and fluidically interconnected via branchings or sub-branches are described within the framework of the present patent application as divided into “levels” designated in ascending or descending alphabetic order depending on the embodiment of the melt conductor and in dependence on the direction of flow of the designated polymer melt. The same applies to branchings and sub-branches which are also designated by levels in ascending or descending order.

The “designated direction of flow” of the polymer melt refers to the arrangement of the melt conductor in the extrusion facility and to the embodiment of the multi-channel system, where the direction of flow is always from an input to an output fluidically connected to the input, independently of whether the polymer melt is distributed and/or mixed in the multi-channel system. In particular, the designated direction of flow of the polymer melt is from an input side to an output side of the melt conductor.

A “multi-channel system” is a channel structure within the melt conductor which is preferably at least partly produced by means of an additive manufacturing method, which is at least partially integrated in the respective melt conductor block and which spatially extends three-dimensionally inside it. The multi-channel system consists of a plurality of fluidically interconnected melt channels which extend from at least one input to at least one output fluidically connected to the input, and which are fluidically interconnected via branchings and sub-branches or via combination ducts, depending on the embodiment of the melt conductor. The melt channels of the multi-channel system are fluidically interconnected behind one another in series or arranged in parallel. With serial arrangement, at least one melt channel of the a^{th} level is fluidically connected to at least one melt channel of the b^{th} level via a branching or sub-branch, the melt channel of the a^{th} level being located upstream or downstream, in the designated direction of flow of the polymer melt, of the respective melt channel of the b^{th} level, depending on the embodiment of the melt conductor as a distributor or a mixer. In other words, the melt channel of the a^{th} level is fluidically connected to the melt channel of the b^{th} level via a branching or a combination duct. In contrast, several, preferably all, melt channels of one level are arranged in parallel.

An “input” of the multi-channel system is the input of the multi-channel system into the respective melt conductor block, in which the polymer melt provided by a provision unit is fed into. In other words, the respective input is arranged at an input side of the respective melt conductor block.

In contrast, an “output” of the multi-channel system is the output of the multi-channel system from the respective melt conductor block from which the polymer melt guided, distributed and/or combined through the respective melt conductor block, exits. The output can be formed as a nozzle and therefore be a nozzle output. Alternatively or in addition, the respective output can be formed such as to feed an extrusion nozzle connected downstream of the melt conductor which accordingly atomizes the polymer melt so as to at least indirectly produce an extrusion product. Therefore, the respective output is arranged at an output side of the respective melt conductor block.

The melt conductor block thus has an input side and an output side, the input side with the respective input being arranged downstream of the provision unit with respect to the designated direction of flow of a polymer melt and the output side with the respective output being arranged upstream of an extrusion nozzle or downstream of the input side with the respective input.

When the present melt conductor is embodied as a melt distributor, the melt conductor has more outputs than inputs since the respective input is preferably fluidically connected to a plurality of outputs via at least two levels of separated melt channels. To prevent a melt flow interruption of the designated polymer melt, protect the multi-channel system from undesired deposits and keep the shearing stresses in the multi-channel system substantially constant, an overall cross-section of all local cross-sections of the melt channels of one level increases with each ascending level. On the one hand, the respective local cross-section of the n melt channels of the b^{th} level decreases in comparison to the respective local cross-section of the m melt channels of the a^{th} level; on the other hand, the number of melt channels increases with each level, that is, with ascending order of the alphabet. In other words, the melt channel of the a^{th} level is oriented towards the input whereas the melt channel of the b^{th} level is oriented towards the output and follows after the melt channel of the a^{th} level in the designated direction of flow of the polymer melt. Correspondingly, a melt channel of the c^{th} level follows after the melt channel of the b^{th} level in the designated direction of flow of the polymer melt etcetera, where the melt channel of the c^{th} level is also oriented towards the output with respect to the melt channels of the a^{th} and the b^{th} level. The melt channel of the b^{th} level is oriented towards the input with respect to the melt channel of the c^{th} level. A melt channel of an a^{th} level is divided into at least two melt channels of a b^{th} level, with a melt channel of the b^{th} level being subdivided into at least two melt channels of a c^{th} level etcetera. Thus, the alphabetic order of the levels of melt channels ascends and the number of melt channels increases from level to level along the designated direction of flow of the polymer melt.

If the present melt conductor is a melt mixer, the melt conductor has more inputs than outputs since at least two of the inputs are fluidically connected to a lower number of outputs via preferably at least two levels of joined melt channels. The overall cross-section of all local cross-sections of the melt channels of one level is reduced with descending levels so as to prevent melt flow interruption of the designated polymer melt and keep the wall shear stresses in the multi-channel system substantially constant. On the one hand, the respective local cross-section of the n melt channels of the b^{th} level increases in comparison to the respective local cross-section of the m melt channels of the a^{th} level; on the other hand, the number of melt channels decreases with each level, that is, with descending order of the alphabet. In other words, using an example of three levels of melt channels in the multi-channel system, the melt channel of the c^{th} level is oriented towards the input whereas the melt channel of the b^{th} level is oriented towards the output and follows after the melt channel of the c^{th} level in the designated direction of flow of the polymer melt. Correspondingly, a melt channel of the a^{th} level follows after the melt channel of the b^{th} level in the designated direction of flow of the polymer melt and is also oriented toward the output with respect to the melt channels of the c^{th} and b^{th} levels. In contrast, the melt channel of the b^{th} level is oriented towards the output with respect to the melt channel of the c^{th} level. This means that at least two melt channels of a c^{th} level are joined to a lower number of melt channels of a b^{th} level, with in turn at least two melt channels of the b^{th} level being joined to a lower number of melt channels of an a^{th} level. Thus, the alphabetic order of the levels of melt channels ascends and the number of melt channels increases from level to level opposite to the designated direction of flow of the polymer melt.

Moreover, it is conceivable to embody the melt conductor partly as a melt distributor and partly as a melt mixer. For example, it is possible that first one melt channel of an a^{th} level is divided into at least two melt channels of a b^{th} level, whereupon one melt channel of a b^{th} level is divided into at least two melt channels of a c^{th} level so that at first the polymer melt is distributed from level to level. At least two melt channels of the c^{th} level can then be recombined to a lower number of melt channels of a b′^{th} level, whereupon at least two melt channels of the b′^{th} level can be recombined to melt channels of the a′^{th} level etcetera so that a combination of the polymer melt takes place from level to level. A reverse order in which first melt channels are joined and then separated as well as any desired combination of distributions and combinations is conceivable depending on the requirements on the polymer melt and the extrusion product produced therefrom.

The wording “oriented towards” within the framework of the invention is to be understood as an arrangement of a melt channel and/or a branching or sub-branch of a first level in relation to a further level. If a multi-channel system has, for instance, a^{th}, b^{th} and c^{th} levels of melt channels, with the a^{th} level being arranged directly at the input of the respective melt conductor block, the c^{th} level directly at the output of the respective melt conductor block and the b^{th} level between the a^{th} and the c^{th} level in the designated direction of flow of the polymer melt, the melt channel of the a^{th} level is oriented towards the input as compared to the melt channels of the b^{th} and c^{th} levels. The melt channel of the c^{th} level is oriented towards the output as compared to the melt channels of the a^{th} and the b^{th} levels. Consequently, the melt channel of the b^{th} level is oriented towards the output as compared to the melt channel of the a^{th} level and on the other hand towards the input as compared to the melt channel of the c^{th} level.

By “extending three-dimensionally”, it is to be understood in the following that the multi-channel system can be formed in up to six different degrees of freedom within the melt conductor block. In other words, a melt channel of the multi-channel system can extend in portions vertically upwards and/or downwards and/or horizontally to the left and/or to the right and/or forth and/or back. Independently of how the multi-channel system within the respective melt conductor block is embodied, at least three of the six degrees of freedom are always used. If, for example, a melt channel of the a^{th} level which extends vertically downward is divided on one common level into two melt channels of the b^{th} level via a branching over substantially 90°, the divided melt channels extend for instance to the left or to the right in the horizontal direction, starting from the melt channel of the a^{th} level. Thus, even with such a simple subdivision of a melt channel, three degrees of freedom are already used. If, however, one of the melt channels is branched out such that at least one of the divided melt channels extends partly at an angle to the level, a fourth and/or fifth degree of freedom is used. In addition, one of the melt channels of the b^{th} level can also be partly guided in opposition to the melt channel guided vertically downward of the a^{th} level, that is, with an opposite direction of flow of the polymer melt, so that the sixth degree of freedom is used as well. Furthermore, a curved embodiment of the multi-channel system or of the melt channels and/or the further branchings in space are conceivable such that several degrees of freedom can be used simultaneously.

A “branching” or “sub-branch” according to the present invention is a nodal point at which a melt channel is divided into at least two melt channels independently of a direction of flow of a polymer melt. A sub-branch is a branch from the second level downward. In a melt distributor, a melt channel of the a^{th} level is divided into two or more melt channels of the b^{th} level via a branching. A melt channel of the b^{th} level is subsequently divided into two or more melt channels of the c^{th} level via a branching into two or more melt channels. In a melt mixer, in contrast, the branching or the sub-branches each function as junctions, with two or more melt channels of the b^{th} level being joined or combined to form a melt channel of the a^{th} level or a lower number of melt channels of the a^{th} level.

By means of a melt conductor in the form of a melt distributor, a polymer melt continuously fed into the melt distributor or multi-channel system of the melt distributor block can be distributed such over a plurality of outputs that the polymer melt can be provided at these outputs or output channels with substantially equal shear stresses. That is, the multi-channel system is preferably embodied such that the polymer melt always has a homogeneous melt history. Furthermore, it is in this manner achieved that the polymer melt is distributed particularly evenly over the output side of the melt conductor and thus can also be provided particularly homogeneously at an extrusion space proximate to one of these output channels in a downward direction, that is, in particular at a collection space and/or an inlet of the extrusion nozzle.

The expression “equal shear stresses” according to the invention substantially describes wall shear stresses between the wall of the multi-channel system and the polymer melt conducted in the respective melt channel, in particular in all branching stages or all levels of the melt channels, the shear stresses being substantially equal or constant or nearly equal or constant and deviating from each other by less than 30%, preferably less than 20% and particularly preferably less than 10%.

By means of a melt conductor in the form of a melt mixer, a polymer melt continuously fed into the melt mixer or multi-channel system of the melt mixer block can be joined such at a lesser number of outputs that the polymer melt can be provided at this/these output(s) with substantially equal shear stresses. In this case as well, the multi-channel system is preferably embodied such that the polymer melt always has a homogeneous melt history at the output. Furthermore, it is in this manner achieved that the polymer melt is joined particularly evenly at the output side of the melt conductor and thus can also be provided in a targeted manner at an extrusion space proximate the output channel(s) in a downward direction, that is, in particular at a collection space and/or an inlet of the extrusion nozzle.

This is mainly achieved by cross-sectional areas of the melt channels which change from one level to the next and the branchings and sub-branches, i.e. junctions, arranged between the melt channel levels.

In the case of a melt distributor, the cross-sectional area of each melt channel of one level is reduced with increasing levels and in the designated direction of flow of the polymer melt, with the sum of melt channels increasing with each ascending level so that melt flows are distributed from level to level in the designated direction of flow.

In the case of a melt mixer, the cross-sectional area of each melt channel of one level is increased with decreasing levels and in the designated direction of flow of the polymer melt, with the sum of melt channels decreasing with each descending level so that melt flows are joined from level to level in the designated direction of flow.

Preferably, the multi-channel system extends through at least two of the melt conductor blocks. In other words, the multi-channel system is only completed when the melt conductor blocks are positioned and assembled with respect to each other. Part of the melt channels of the multi-channel system extends, forming a first partial channel system, through a first melt conductor block, and another part of the melt channels extends, forming a second partial channel system, through at least one second melt conductor block, the melt channels of the first melt conductor block being fluidically connected to the melt channels of the second melt conductor block.

If, for instance a first and a second melt conductor block are serially connected, a respective output of the first melt conductor block opens into an input of the second melt conductor block.

In contrast, if two melt conductor blocks are connected, for example, in parallel, the melt channels can have channel inputs and/or channel outputs at the lateral surfaces or at contact surfaces contacting each other of the melt conductor blocks, which in- and/or outputs fluidically connect a melt channel of the first partial channel system formed in the first melt conductor block with a melt channel of the second partial channel system formed in the second melt conductor block.

Furthermore, in case of, for instance, two melt conductor blocks switched or arranged in parallel, the melt channels can have channel inputs and/or channel outputs at the lateral surfaces or at contact surfaces contacting each other, which inputs and/or outputs form partial collection chambers forming in turn one common collection chamber which extends over at least two melt conductor blocks switched in parallel and in which the polymer melt is distributed evenly and is transferred into the melt channels of the respective formed partial channel systems of the respective melt conductor block with a same melt history.

In this context, a “partial channel system” is understood to be a portion of the multi-channel system formed or arranged in the respective melt conductor block, the sum of all partial channel systems forming the multi-channel system. The total multi-channel system is only completed after assembly of the melt conductor blocks in the extruding die. The partial channel systems are thus fluidically interconnected.

Preferably, a tensioning system is provided by means of which the melt conductor blocks can be mutually tensioned to form one block unit. By “tensioning” of the melt conductor blocks with the tensioning system, it is intended that the tensioned melt conductor blocks are first positioned with respect to each other, during assembly, and this position is then secured such that a relative movement of the melt conductor blocks is prevented and at the same time optimal alignment of the fluidically directly interconnected inputs, outputs and/or melt channels of the contacting melt conductor blocks is ensured. Tensioning can in particular take place hydraulically and/or mechanically and/or thermally.

The advantage of such a system is that any number of melt conductor blocks can be mutually coupled such that the melt conductor is modular. In this manner, a melt conductor of any shape and size can be achieved in which melt conductor blocks switched serially and/or in parallel are tensioned together to form a block unit at least indirectly forming the melt conductor.

It is explicitly pointed out that a device having the features in the above paragraphs, even taken by itself, represents an independent aspect of the invention, independently of the independent Claim described above. An independent, advantageous disclosed combination of features would therefore be the following:

Melt conductor, in particular melt distributor or melt mixer, for an extruding die of an extrusion facility, having two or more melt conductor blocks with a multi-channel system, the multi-channel system extending three-dimensionally inside at least two of the melt conductor blocks, the melt conductor comprising a tensioning system by means of which the melt conductor blocks can be mutually tensioned to form one block unit.

In one example of embodiment, the tensioning system comprises a retention device with a frame part which can be thermally activated and by means of which at least two of the melt conductor blocks can be tensioned with respect to each other.

By “thermal activation of the frame part” of the retention device, it is intended that the frame part performs tensioning of the melt conductor blocks only if it undergoes thermal expansion under the influence of temperature. The melt conductor blocks expand thermally and interact with the retention device or the frame part thereof, which can be thermally activated, in particular when the melt conductor blocks are heated up during operation, at least by the molten polymer conveyed through the multi-channel system and preferably by additional temperature regulation of the melt conductor blocks. Due to temperature-related change of the geometrical dimensions of the melt conductor blocks, the frame part achieves a mutual tensioning effect of the melt conductor blocks. Thus, the frame part achieves tensioning of the melt conductor blocks to form a coherent block unit.

It is explicitly pointed out that a device having the features in the above paragraphs, even taken by itself, represents an independent aspect of the invention, independently of the independent Claim described above. An independent, advantageous disclosed combination of features would therefore be the following (an analogous method of joining the melt conductor blocks and the frame part being independently advantageous as well):

Melt conductor, in particular melt distributor or melt mixer, for an extruding die of an extrusion facility, having two or more melt conductor blocks with a multi-channel system, the multi-channel system extending three-dimensionally inside at least two of the melt conductor blocks, the melt conductor comprising a retention device with a frame part which can be thermally activated, at least two of the melt conductor blocks being tensioned with respect to each other during assembly and operation due to a temperature difference between frame part and melt conductor blocks.

Preferably, the melt conductor blocks have positioning means with which the at least two melt conductor blocks can be positioned with respect to one another. The positioning means is/are preferably formed on contact surfaces of the melt conductor blocks contacting each other and can be manufactured, like the rest of the respective melt conductor block, by means of an additive manufacturing method, preferably directly together with the respective melt conductor block. The positioning means are provided for positive connection of at least two melt conductor blocks. For instance, a projection can be formed on a first melt conductor block which engages in a recess formed in the second melt conductor block and thus achieves, on the one hand, direct positioning of the melt conductor blocks with respect to each other and, on the other hand, a positive connection. In other words, male and female connectors are formed on the melt conductor blocks which allow direct positioning after assembly of the melt conductor blocks so that additional alignment of the blocks in relation to one another becomes unnecessary. Preferably, the male and the female connectors are encoded and positioned with respect to each other such that the melt conductor blocks can only be positioned in the envisaged order and orientation, preventing incorrect assembly of the melt conductor. By adhesive bonding or welding, the melt conductor blocks to be interconnected can additionally be fixed into position. Thus, the melt conductor blocks can be interconnected by material engagement.

It is explicitly pointed out that a device having the features in the above paragraphs, even taken by itself, represents an independent aspect of the invention, independently of the independent Claim described above. An independent, advantageous disclosed combination of features would therefore be the following:

Melt conductor, in particular melt distributor or melt mixer, for an extruding die of an extrusion facility, having two or more melt conductor blocks with a multi-channel system, the multi-channel system extending three-dimensionally inside at least two of the melt conductor blocks, the melt conductor blocks having positioning means by means of which at least two of the melt conductor blocks can be prepositioned with respect to one another.

Preferably, connection means are provided, in particular for threaded connection and/or adhesive bonding of the melt conductor blocks. “Connection means” are especially embodied to achieve a positive and/or frictional connection and/or a connection by material engagement between the melt conductor blocks to be tensioned with respect to one another. Two melt conductor blocks, but also three or more melt conductor blocks can be mutually connected. A threaded connection preferably comprises a threaded bolt and a nut, the threaded bolt being at least partly accommodated by the melt conductor blocks. An adhesive bond can comprise a single-component or multi-component adhesive arranged between the melt conductor blocks to be bonded.

It is explicitly pointed out that a device having the features in the above paragraphs, even taken by itself, represents an independent aspect of the invention, independently of the independent Claim described above. An independent, advantageous disclosed combination of features would therefore be the following:

Melt conductor, in particular melt distributor or melt mixer, for an extruding die of an extrusion facility, having two or more melt conductor blocks with a multi-channel system, the multi-channel system extending three-dimensionally inside at least two of the melt conductor blocks, means for connection, especially for threaded connection and/or adhesive bonding, of the melt conductor blocks being provided.

Optionally, the connection means comprise a tie rod guided through at least two of the melt conductor blocks, which tensions at least two melt conductor blocks with respect to one another. For this purpose, the melt conductor blocks to be tensioned advantageously have through openings or throughput openings through which the tie rod is directed. The tie rod can for instance be arranged in parallel to a global machine direction or at an angle, for instance at an incline, in particular transversely thereto.

A “global machine direction” is the arrangement of the melt conductor, in particular the melt conductor block, in the extrusion facility, the global machine direction extending along the designated direction of flow between the provision unit and possibly an extrusion nozzle or the nozzle outputs on the melt conductor block. That is, the global machine direction is a spatial extension of the melt conductor, in particular the melt conductor block, in the extrusion facility taking into account the input side and the output side of the multi-channel system for the designated polymer melt.

A “local machine direction” may deviate locally from the global machine direction, the local machine direction referring to the local orientation of the multi-channel system in particular of the respective melt channel in relation to the global machine direction. The local machine direction extends coaxially with the longitudinal axis of the melt channel in the designated direction of flow of the polymer melt. In a particularly simplified case, the local machine direction can in portions preferably coincide with the global machine direction if the multi-channel system has an input on an input side of the melt conductor block and an output, which is fluidically connected and coaxially arranged therewith, on an output side of the melt conductor block opposite to the input side. The orientation of the melt channel in space and thus the local machine direction can, in this case, be at least partially coaxial with the global machine direction.

Since the multi-channel system is formed so as to extend three-dimensionally inside the melt conductor or the melt conductor block, respectively, the local machine direction regularly deviates from the global machine direction. Because all six degrees of freedom can be exploited to form the multi-channel system, an inclined arrangement of the respective melt channel with respect to the global machine direction is possible. It is also conceivable and can be advantageous, especially for saving installation space, to provide for the local machine direction to extend, in portions, opposite to the global machine direction.

Thus, in a particular example of embodiment, melt channels of the multi-channel system can be guided back nearly to the input side of the melt conductor, in particular the melt conductor block. The advantage of guiding the local machine direction of the melt channels opposite to the global machine direction therefore consists in the fact that since any desired arrangement of the melt channels in relation to the global machine direction is possible, the melt conductor or melt conductor block can be embodied such as to save a large amount of installation space. In addition, the melt channels can be arranged to bypass connecting or fastening elements as desired, in particular screws, threads or the like.

It is explicitly pointed out that a device having the features of the above paragraphs, even taken by itself, represents an independent aspect of the invention, independently of the independent Claim described above. An independent, advantageous disclosed combination of features would therefore be the following:

Melt conductor, in particular melt distributor or melt mixer, for an extruding die of an extrusion facility, having two or more melt conductor blocks with a multi-channel system, the multi-channel system being arranged within at least two of the melt conductor blocks with three-dimensional extension, connection means, in particular for threaded connection and/or adhesive bonding of the melt conductor blocks, being provided, the connection means comprising a tie rod which is guided through at least two of the melt conductor blocks and which tensions at least two melt conductor blocks with respect to one another.

Further preferably, a seal is arranged at a contact surface between two melt conductor blocks in contact with each other. The seal can be a sealing ring, a sealing lip or the like and is in particular provided to seal the multi-channel system with respect to an outer atmosphere. In addition, the seal prevents humidity or dirt from entering the multi-channel system.

It is explicitly pointed out that a device having the features of the above paragraphs, even taken by itself, represents an independent aspect of the invention, independently of the independent Claim described above. An independent, advantageous disclosed combination of features would therefore be the following:

Melt conductor, in particular melt distributor or melt mixer, for an extruding die of an extrusion facility, having two or more melt conductor blocks with a multi-channel system, the multi-channel system extending three-dimensionally inside at least two of the melt conductor blocks, a seal being arranged at a contact surface between two contacting melt conductor blocks.

The invention includes the technical teaching that two or more multi-channel systems extend through at least two melt conductor blocks, a channel output of a k^{th} multi-channel system of the first melt conductor block being uniquely allocated to a channel input of a k^{th} multi-channel system of the second melt conductor block and vice versa. In other words, the melt conductor and in particular the melt conductor blocks are constructed such that the multi-channel system extends three-dimensionally through at least two of the melt conductor blocks, all melt conductor blocks acting as one block unit during operation of the extrusion facility and no geometrical imperfections occurring at the interfaces between the melt conductor blocks, in particular between the fluidically connected melt channels. Preferably, all channel outputs of the melt channels of a first partial channel system of the first melt conductor block are aligned with channel inputs of melt channels of a second partial channel system of the second melt conductor block fluidically connected thereto, the respective channel output and the respective channel input ideally having identical cross-sections so as to avoid undesired shear stress variations, demixing and/or deposits in the multi-channel system.

It is explicitly pointed out that a device having the features of the above paragraphs, even taken by itself, represents an independent aspect of the invention, independently of the independent Claim described above. An independent, advantageous disclosed combination of features would therefore be the following:

Melt conductor, in particular melt distributor or melt mixer, for an extruding die of an extrusion facility, having two or more melt conductor blocks with two or more multi-channel systems, the multi-channel systems extending three-dimensionally inside at least two of the melt conductor blocks, a channel output, in particular several or all channel outputs, of a k^{th} multi-channel system of the first melt conductor block are, preferably and inversely, uniquely allocated to a k^{th} multi-channel system of the second melt conductor block.

Preferably, the melt conductor block further has a medium channel, in particular for a circulating fluid supply, especially for temperature control, and/or for an electric line and/or a measuring device.

A “medium channel” in this context refers to an additional channel system formed in addition to the multi-channel system and fluidically separated therefrom, but which can basically be formed similar to the multi-channel system in structure. This means that the medium channel as well can extend three-dimensionally through the melt conductor block and has an input as well as an output fluidically connected therewith. The medium channel extends spatially separated between the melt channels of the multi-channel system and can be operatively connected to it. The medium channel can be formed, for instance, to conduct a medium, in particular a temperature control medium. Other than the hollow chamber system, the medium channel is a separate channel that saves space or a separate channel system by means of which an interaction with the designated polymer melt conducted in the melt channels can be effected. In addition, the medium channel or another medium channel can be designed for guiding electric lines and/or a measuring unit, such as, for instance, a sensor system with the corresponding electric supply line. Due to additive manufacturing thereof, the multi-channel system can be formed so as to bypass the medium channel (which can also be manufactured additively), or vice versa. The support structures mentioned above can equally be employed for achieving static stability of the medium channel. The interfaces described above, i.e. channel outputs and inputs, can equally be used for connecting the medium channel between at least two melt conductor blocks.

It is explicitly pointed out that a device having the features of the above paragraphs, even taken by itself, represents an independent aspect of the invention, independently of the independent Claim described above. An independent, advantageous disclosed combination of features would therefore be the following:

Melt conductor, in particular melt distributor or melt mixer, for an extruding die of an extrusion facility, having a melt conductor block with a multi-channel system, the multi-channel system extending three-dimensionally inside the melt conductor block, the melt conductor, in particular the melt conductor block, having a medium channel which is spatially arranged between melt channels of the multi-channel system, in particular for a circulating fluid supply, especially for temperature control, and/or for an electric line and/or for a measuring device.

In one embodiment, the melt conductor block has a static functional element for influencing the designated polymer melt at least indirectly. A “static functional element” is at least one substantially stationary element or component arranged at or in the multi-channel system, which interacts with the designated polymer melt. The static functional element influences the designated polymer melt in such a way that the properties, in particular the flow properties, of the polymer melt remain substantially the same or are preferably improved from the input to the output. In particular, the static functional element can make a melt temperature of the melt stream more homogeneous. Also, deposits and/or demixing of the polymer melt in the multi-channel system can be prevented by homogenization of the melt stream.

The static functional element is preferably a static mixing element. The mixing element is preferably arranged inside the multi-channel system or in a melt channel of the multi-channel system and is preferably manufactured, with additive manufacturing of the multi-channel system, at least partially by additive manufacturing as well. The mixing element can be ramp-shaped, rod-shaped, curved or the like and is mainly designed for mixing and homogenizing the designated polymer melt. Due to the shear stresses inside the polymer melt, the melt stream has different flow rates in the melt channel, which decrease from a central axis of the melt channel in the direction of the melt channel wall. The static functional element, in particular the static mixing element, in this context homogenizes the melt strand conducted inside the melt channel. For instance, directly before an output of the multi-channel system, homogenization of the melt flow through a static mixing element can achieve homogeneous feeding of an extrusion nozzle or of a collection chamber arranged upstream of the extrusion nozzle.

The static mixing element is preferably arranged inside the melt channel between two branchings or sub-branches. It is conceivable that in the area of the mixing element, a minor local change in cross-section of the melt channel is formed, especially for improving a mixing effect. Preferably, a local widening of the melt channel is provided which is formed in dependence on the flow characteristics inside the respective melt channel, the static mixer being formed inside the local widening portion. The melt channel preferably has substantially the same cross-sectional size and shape before and after the local widening portion of the melt channel, a locally enlarged cross-section being formed therebetween in the designated direction of flow of the polymer melt. The change in cross-section can be step-shaped and/or ramp-shaped. Furthermore, it is advantageous if after a change in direction of the melt channel, the polymer melt or the melt flow, respectively, is directed from the central axis of the respective melt channel in the direction of the wall of the melt channel by a simple static mixing element.

It is explicitly pointed out that a device having the features in the above paragraphs, even taken by itself, represents an independent aspect of the invention, independently of the independent Claim described above. An independent, advantageous disclosed combination of features would therefore be the following:

Melt conductor, in particular melt distributor or melt mixer, for an extruding die of an extrusion facility, having a melt conductor block with a multi-channel system, the multi-channel system extending three-dimensionally inside the melt conductor block, the melt conductor, in particular the melt conductor block, having a static functional element for at least indirectly influencing the designated polymer melt flowing under pressure through the multi-channel system.

The invention includes the technical teaching that the melt conductor block has a first multi-channel system and a second multi-channel system and in particular a third, fourth or fifth multi-channel system. It is conceivable that the multi-channel systems are fluidically separated or that at least two multi-channel systems are combined in order to combine the polymer melts of the combined multi-channel systems. More than five multi-channel systems are conceivable as well which are at least partly formed by means of an additive manufacturing method within the melt conductor block. The multi-channel systems can conduct identical, but also different or partly identical and partly different polymer melts so as to produce, for instance, multilayer or at least partly overlapping film webs or filaments. Also with regard to material requirements and properties, different polymer melts can be conducted in the multi-channel systems, joined and distributed so as to produce an extrusion product. Furthermore, it is also possible to produce individual filaments from polymer melts of different multi-channel systems. Filaments can be formed from different components, i.e. polymer melts with various mixing ratios, the components being arranged, for instance, adjacent to one another, in layers, sheets and/or segments in the respective filament.

From a plurality of filaments, non-woven fabrics with equal or different material properties can be produced. A non-woven fabric consists of a plurality of individual filaments, preferably 20 to 10,000 individual filaments per meter width of the fabric. The outputs of the respective multi-channel system can be embodied for atomizing the polymer melt so as to form a filament. It is also possible that the extrusion nozzle downstream of the melt conductor block is provided to produce the filaments and then the non-woven fabric.

In a second aspect of the invention, the task is solved by an extruding die for an extrusion facility for the production of extrusion products, comprising a melt conductor of the type described above, the melt conductor being adapted for distributing and/or mixing at least one polymer melt.

An “extruding die” is an assembly of an extrusion facility comprising one or more melt conductors with one or more melt conductor blocks each. The extruding die is fed with polymer melt which is at least indirectly conducted into the melt conductor or a multi-channel system of a melt conductor block of the melt conductor. Upstream of the extruding die, a provision unit in the form of an extruder or the like is arranged for providing the designated polymer melt.

Downstream of the melt conductor or of the respective melt conductor block, preferably at least one extrusion nozzle segment is arranged, the melt conductor or the respective melt conductor block being adapted to at least partially feed the respective extrusion nozzle segment with polymer melt. Thus, the extruding die has two or more extrusion nozzle segments which in turn may form at least one coherent extrusion nozzle with a respective extrusion nozzle output, which extrusion nozzle may be part of the extruding die. For intermediate forming or final forming of the extrusion product, the extrusion nozzle segments are combined or connected such that a common extrusion nozzle output is formed which guarantees homogeneous forming of the polymer melt.

Alternatively, each melt conductor block can already comprise an extrusion nozzle integrally connected to it, or it can be formed as an extrusion nozzle or assume the functions of an extrusion nozzle such that a separate extrusion nozzle becomes unnecessary. For this purpose, the respective output of the multi-channel system on the output side of the melt conductor block is accordingly formed and dimensioned such that atomization of the designated polymer melt takes place. In this case, the sum of all outputs on the melt conductor is called “extrusion nozzle output”, where the extrusion nozzle output can be embodied as desired depending on the arrangement of the outputs with respect to each other in terms of height and width. The extrusion nozzle output preferably has a width many times larger than its height, for instance for producing films or non-woven fabrics.

Like the melt conductor, the separate extrusion nozzle and correspondingly also the extrusion nozzle output can at least partly be produced by means of an additive manufacturing method. Such a method is a particularly uncomplicated way of producing various geometries of the extrusion nozzle and the extrusion nozzle output as well as respective connecting means for positively and frictionally connecting the extrusion nozzle to the melt conductor.

The extrusion nozzle output of the extruding die preferably has a width of more than 5,000 mm, preferably more than 6,000 mm or more than 8,000 mm. By at least partially additive manufacturing of the extruding die, in particular the extrusion nozzle output, dimensions can be achieved which have not been possible up to now. In particular, the extrusion nozzle and the extrusion nozzle output can be overdimensioned. In addition, worn or defective parts can be replaced faster. Moreover, the extrusion nozzle and/or the extrusion nozzle output can be multipart, which allows in particular precisely fitting components with low tolerances.

In a third aspect of the invention, the task is solved by an extrusion facility for manufacturing extrusion products, comprising an extruding die of the type described above. The extrusion facility is in particular provided for processing polymer melts and for manufacturing extrusion products. The extrusion facility is fed with polymer melt by a provision unit comprising a silo and/or an extruder or the like. The advantage of such an extruding die is that due to the manufacturing method thereof, a particularly quick an easy replacement of the melt conductor, the respective melt conductor block, any extrusion nozzle present and/or any extrusion nozzle output present at the nozzle, for instance for repair and/or maintenance purposes, is possible. In addition, extrusion products can be manufactured in oversize, especially in overwidth, since the extruding die can have any desired shape and size, in particular any width. By switching the melt conductor blocks in parallel or in series, it is possible to manufacture extrusion products with dimensions which have not been possible up to now, especially in overwidth.

The extrusion facility with the melt conductor according to the invention can be embodied as a device for manufacturing filaments or fibers. Such devices have a dot-shaped polymer melt output at the extruding die or at the melt conductor block of the melt conductor in common, several small nozzle bores being formed on the output side. As endless filaments, the fibers form, for instance, nonwoven fabrics, mono- or multi-filaments or small tapes. During this process, the melt conductor according to the invention is advantageously employed as a melt distributor of the shaping extruding die for distributing the polymer melt.

In particular, the melt conductor according to the invention can be employed in a device for manufacturing non-woven fabrics made of endless filaments (called a spunbound line), substantially consisting of a spinning device for spinning filaments, a cooling device for cooling the filaments, a stretching device for stretching the filaments, a depositing unit, in particular a deposit filter belt, for depositing the filaments to form a non-woven web, a solidification unit for solidifying the filaments of the non-woven web and a winding unit for winding the non-woven web.

The spinning device substantially consists of at least one gravimetric or volumetric dosing unit for dosing and feeding at least one polymer component to an extruder or to a provision unit, at least one extruder or one provision unit for compacting, melting and conveying the at least one polymer component, at least one melt filter ideally acting as a screen changer with or without automatic cleaning for filtering particles from the polymer melt, at least one melt and/or viscose pump for conveying the polymer melt, at least one melt conductor formed as a melt distributor evenly distributing the polymer melt substantially transversely to the global machine direction or in “cross direction” (CD) of the device, possibly at least one additional melt conductor embodied as a melt distributor which additionally distributes the polymer melt transversely to the global machine direction but also perpendicularly to the “cross direction” (CD) in what is called a “machine direction” (MD) of the device, a one- or multipart nozzle die of the extruding die for producing filaments from polymer melt and rigid and/or flexible tubings for connecting the abovementioned units. The melt conductor according to the invention is in particular employed as a melt distributor for distributing the polymer melt.

The invention can likewise be employed in a device for manufacturing non-woven fabrics made of ultrafine endless filaments (called a smelting and blowing plant), substantially consisting of at least one blowing device for producing and subsequently cooling ultrafine filaments, a depositing unit, in particular a depositing roller, for depositing the ultrafine filaments to form a non-woven web, a solidification unit for solidifying the filaments to form a non-woven web and a winding unit for winding the non-woven web.

The spinning device substantially consists of at least one gravimetric or volumetric dosing unit for dosing and feeding at least one polymer component to an extruder or to a provision unit, at least one extruder or one provision unit for compacting and melting the at least one polymer component, at least one melt filter ideally acting as a screen changer with or without automatic cleaning for filtering particles from the polymer melt, at least one melt and/or viscose pump for building up continuous pressure on the polymer melt, at least one melt conductor formed as a melt distributor evenly distributing the polymer melt in the “cross direction” (CD) of the device, possibly at least one additional melt conductor embodied as a melt distributor which additionally distributes the polymer melt in the “machine direction” (MD) of the device, a one- or multipart nozzle die of the extruding die for producing ultrafine filaments from polymer melt and rigid and/or flexible tubings for connecting the abovementioned units. The melt conductor according to the invention is in particular employed as a melt distributor for distributing the polymer melt.

In another embodiment, the extrusion facility according to the invention with the melt conductor according to the invention can be a device for manufacturing plates or flat films. Such devices have in common that a linear polymer melt output is formed at the extruding die, in particular at the melt conductor block of the melt conductor, causing the extrusion product to have at least one upper and one lower face. The melt conductor is advantageously employed as a melt distributor of the shaping extruding die for distributing the polymer melt.

In a further embodiment, the melt conductor according to the invention can be employed in a device for manufacturing flat films (called a flat-film line), comprising a unit for providing a polymer melt, a slot die or a die for producing a plate-shaped polymer melt stream and a cooling roller unit.

The unit for providing a polymer melt substantially consists of at least one gravimetric or volumetric dosing unit for dosing and feeding at least one polymer component to an extruder, at least an extruder for compacting, melting and conveying the at least one polymer component, at least one melt filter ideally acting as a screen changer with or without automatic cleaning for filtering particles from the polymer melt, optionally a melt and/or viscose pump for conveying the polymer melt, optionally a melt mixer for creating a multi-layered structure of the melt stream, a melt conductor embodied as a melt distributor for distributing the melt stream in the “cross direction” (CD), an extrusion nozzle formed as a slot die for forming a plate-shaped polymer melt stream and rigid and/or flexible tubings for connecting the abovementioned units. The melt conductor can be embodied as a melt distributor, a melt mixer or a combination of both.

In another variant, the extrusion facility according to the invention with the melt conductor according to the invention can be embodied as a device for manufacturing pipes, profiles or tubings. Such devices provide for a polymer melt output which produces interior and exterior surfaces of the extrusion product by a correspondingly shaped melt channel guide and/or supplementary installations. Advantageously, the melt conductor according to the invention is employed as melt distributor of the shaping extruding die for distributing the polymer melt.

In another variant, the extrusion facility according to the invention with the melt conductor according to the invention can be embodied as a device for manufacturing a tubular film. Such a device has an at least partly circular polymer melt output at the extruding die which comprises an annular gap, providing the extrusion product with an inner and an outer face. The melt conductor according to the invention is advantageously employed as a melt distributor of the shaping extruding die for distributing the polymer melt.

In particular, the melt conductor according to the invention can be employed in a device for manufacturing blown films (called a blow-molding plant), substantially consisting of a unit for providing a polymer melt, i.e. a provision unit, a blowing head for producing a tubular film, a take-off unit for taking off and stretching the tubular film in the transverse and longitudinal extrusion directions and a cooling unit for cooling the tubular film.

The unit for providing a polymer melt, i.e. the provision unit, substantially consists of at least one gravimetric or volumetric dosing unit for dosing and feeding at least one polymer component to an extruder, at least one extruder for compacting, melting and conveying the at least one polymer component, at least one melt filter ideally acting as a screen changer with or without automatic cleaning for filtering particles from the polymer melt, optionally a melt and/or viscose pump for conveying the polymer melt and rigid and/or flexible tubings for connecting the abovementioned units and the blowing head which is to be understood as an extruding die according to the invention with a melt distributor, in particular a spiral or plate distributor; the blowing head comprising a slot die with spiral distributor, in particular a radial spiral distributor for forming a one- or multilayered annular polymer melt stream as well as an inflation unit for inflating a tubular film. The melt conductor according to the invention is thus in particular employed as a melt distributor for distributing the polymer melt.

In a fourth aspect of the invention, the task is solved by a method of operating an extrusion facility according to the embodiment described above, the extrusion facility being fed at least one extrudable polymer, in particular at least one plastic, which is plasticized to form a respective polymer melt, the polymer melt being fed to a melt conductor of the type described above which distributes and/or mixes the polymer melt.

Feeding of the extrudable polymer takes place, for instance, via a silo or a conveying unit which is either part of the extrusion facility or a separate component or assembly. The extrudable polymer can be fed to the extrusion facility as a granulate, that is, in substantially solid form, or as an at least partially molten melt.

After being fed into the extrusion facility, granulate can be processed by a provision unit, in particular an extruder or the like, and plasticized by melting and/or additional processing steps such that it can be fed to the melt conductor as a polymer melt for combination and/or separation. After separation and/or combination, the polymer melt can be fed from the melt conductor to an extrusion nozzle which further processes the polymer melt to obtain the extrusion product.

It is an advantage of such a facility that with such an extruding die, it can be operated much more economically since product change times are much shorter with a change of polymer and the overall operating time of the extruding die before die cleaning are substantially longer.

All components of the extrusion facility which are described within the framework of this invention as additively manufactured components, in particular the extruding die, the melt conductor and the melt conductor block, are formed from a material suitable for additive manufacturing and/or casting. Particularly suited materials are metal, plastics and/or ceramics. By “plastics”, preferably high-performance plastics are intended which allow for operating temperatures of the extruding die of more than 200° C. An advantage of components additively manufactured from ceramics, in particular melt channels additively manufactured from ceramics, is the minimization of deposits. Advantageously, the surfaces of the melt channels which come in direct contact with the polymer melt are formed as one- or multilayer ceramic sheets in the form of inliners, from a material which differs from the already available melt conductor block. In other words, portions of the channels of the respective multi-channel system can have a one- or multilayer ceramic sheet for channel-surface modification. It is also conceivable, however, to form the entire melt conductor block partly or entirely from ceramics. In other words, different segments of the melt conductor block with the multi-channel system can consist of different materials whose advantages can be exploited for the respective application case. They can in particular be different metals or a combination of metal, ceramics and/or plastics.

Depending on the material of the melt conductor block and/or the channels of the multi-channel system, alternatively a surface treatment for finishing the surface of the channels of the multi-channel system can take place. It can comprise a heat treatment, a chemical vapor-phase deposit, a physical vapor-phase deposit, an infiltration or the like. In this manner, a coating with one or more layers, in particular on the channel surfaces of the multi-channel system, is formed, influencing the surface condition of the channels, so that advantageously flow properties of the polymer melt are improved and deposits within the multi-channel system reduced.

After manufacturing of the melt conductor block, the inner surface of the channels of the multi-channel system and the coating of the channels, if any, can be subjected to finishing treatment. This may comprise cleaning and/or flushing of the multi-channel system. Flow grinding of the channels of the multi-channel system is possible as well. These steps can also be performed in maintenance intervals or in case of a change of product so as to detach and remove any deposits in the multi-channel system.

Naturally, features of the solutions described above or in the Claims can also be combined, if desired, so as to cumulatively achieve the advantages and effects which are achievable in this case.

Other features, effects and advantages of the present invention are described by means of the figure and the following specification in which a continuously polymer-processing extrusion facility and examples of embodiment of different melt conductors are presented and described by way of example.

Components which at least substantially have the same functions can be indicated by the same reference numbers in the individual figures; where the components are not necessarily referenced and explained in every single figure.

In the drawings:

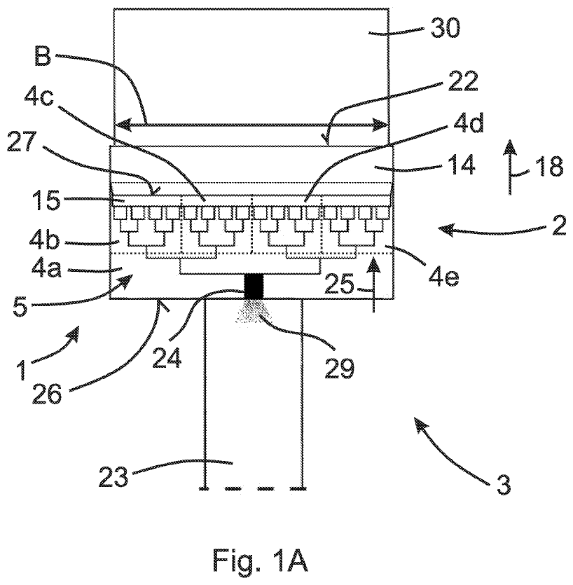

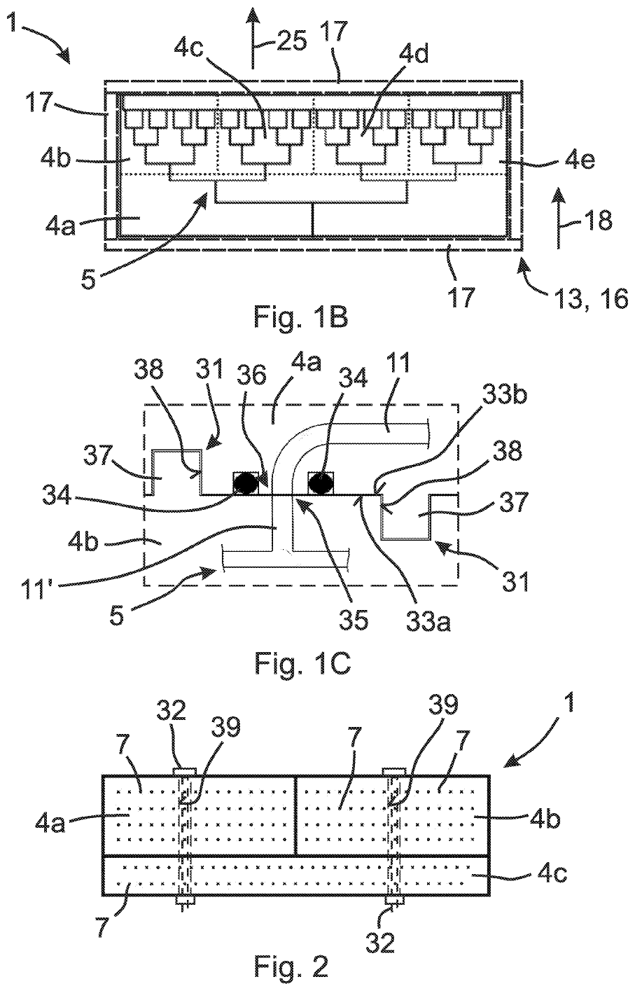

FIG. 1A is a schematic view of a possible structure of an extrusion facility having a melt conductor comprising several melt conductor blocks and a multi-channel system according to a first alternative;

FIG. 1B is schematic view of the melt conductor according to FIG. 1A;

FIG. 1C is a simplified detailed view of an interface between two melt conductor blocks according to FIG. 1A and FIG. 1B;

FIG. 2 is a schematic view of an output side of the melt conductor according to a second alternative example of embodiment;

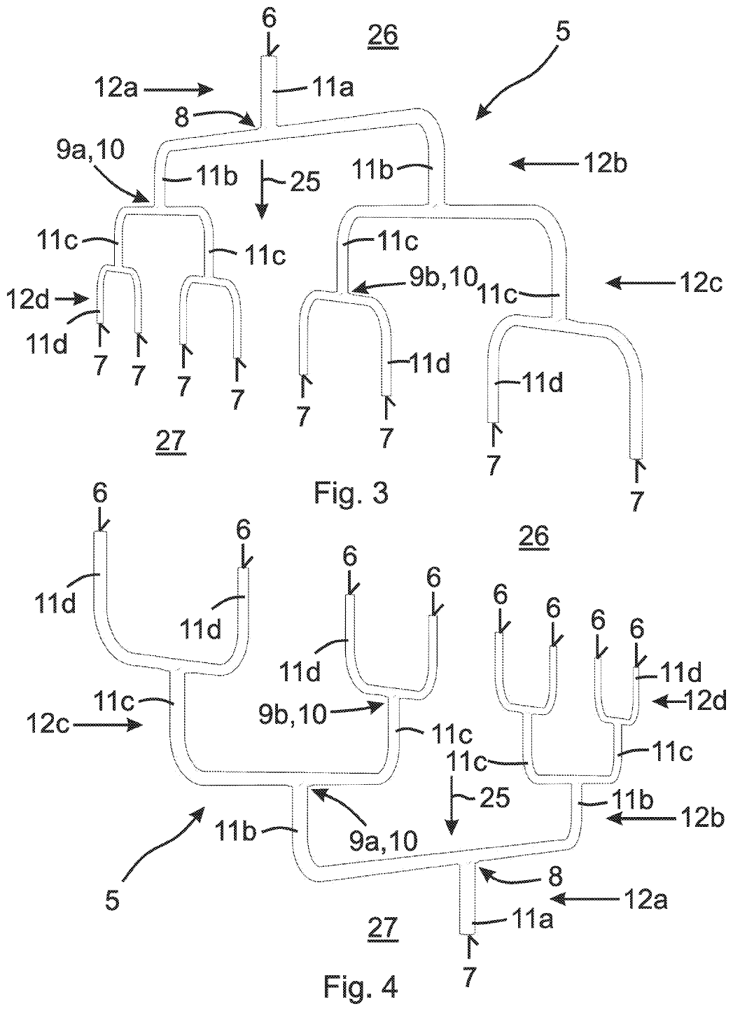

FIG. 3 is a schematic perspective view of the multi-channel system according to FIGS. 1A through 1C, the melt conductor being embodied as a melt distributor;

FIG. 4 is a schematic perspective view of a third alternative embodiment of the multi-channel system, the melt conductor being embodied as a melt mixer;

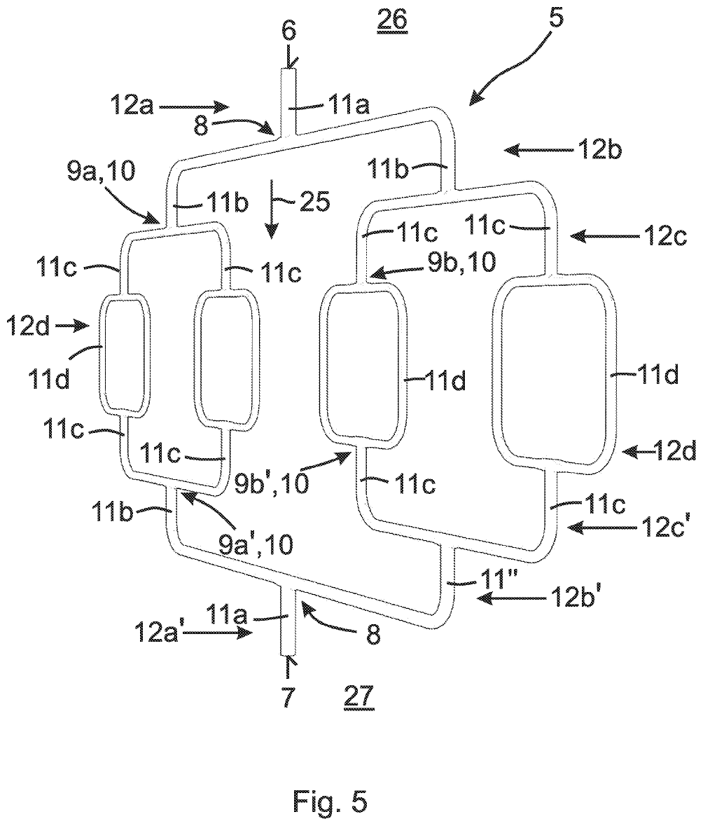

FIG. 5 is a schematic perspective view of a fourth alternative embodiment of the multi-channel system, the melt conductor being partly embodied as a melt distributor and partly as a melt mixer;

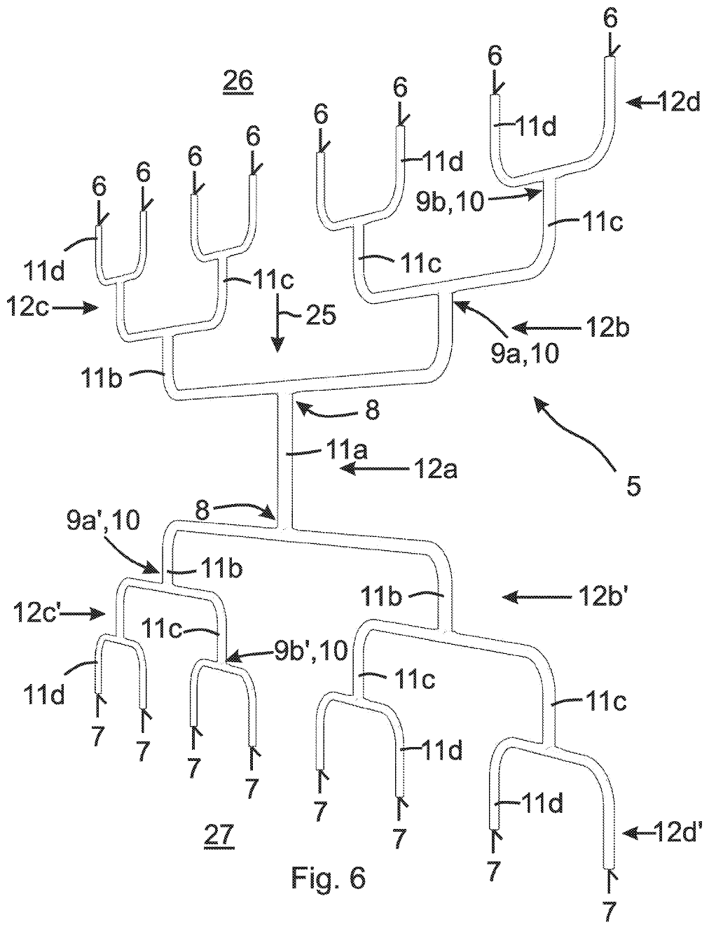

FIG. 6 is a schematic perspective view of a fifth alternative embodiment of the multi-channel system, the melt conductor being partly embodied as a melt mixer and partly as a melt distributor;

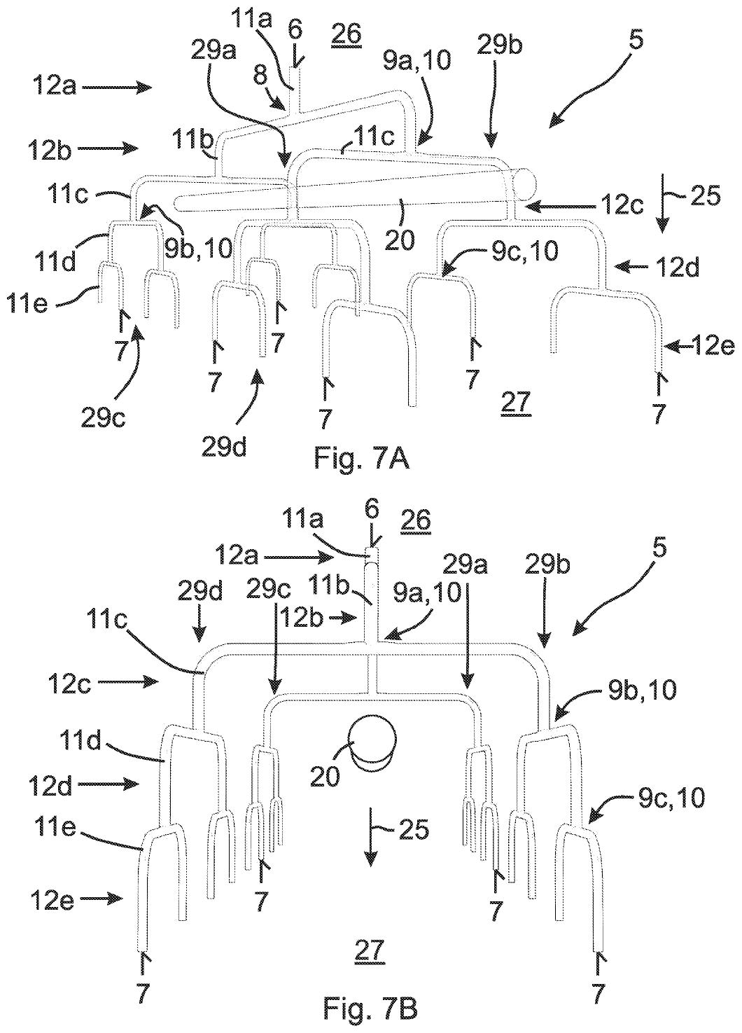

FIG. 7A is a schematic perspective view of a sixth alternative embodiment of the multi-channel system, the melt conductor being embodied as a melt distributor;

FIG. 7B is another schematic perspective view of the sixth alternative embodiment according to FIG. 7A;

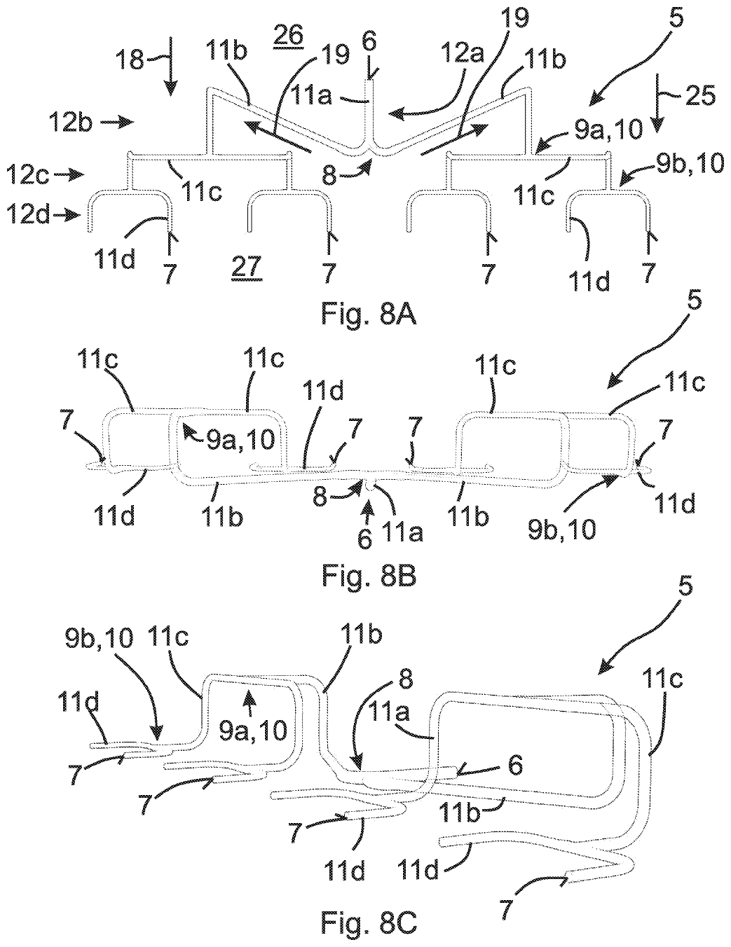

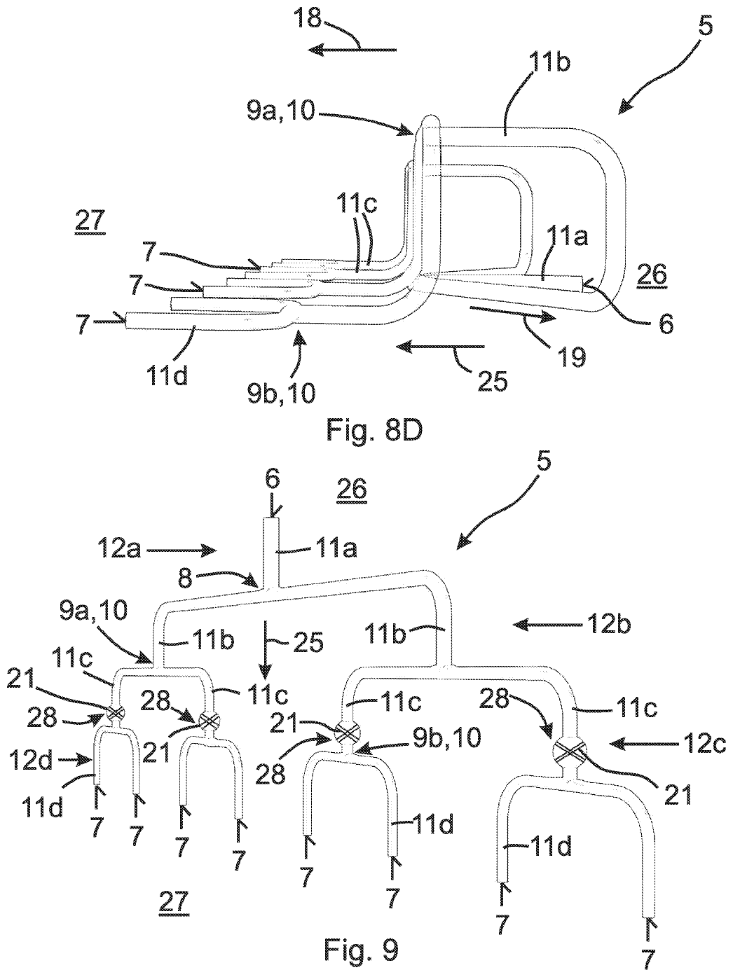

FIG. 8A is a schematic top view of a seventh alternative embodiment of the multi-channel system, with the melt conductor being embodied as a melt distributor;

FIG. 8B is a schematic perspective view of the seventh alternative embodiment according to FIG. 8A;

FIG. 8C is another schematic perspective view of the seventh alternative embodiment according to FIGS. 8A and 8B;

FIG. 8D is another schematic perspective view of the seventh alternative embodiment according to FIGS. 8A through 8C;

FIG. 9 is a schematic perspective view of an eighth alternative embodiment of the multi-channel system, the melt conductor being embodied as a melt distributor;

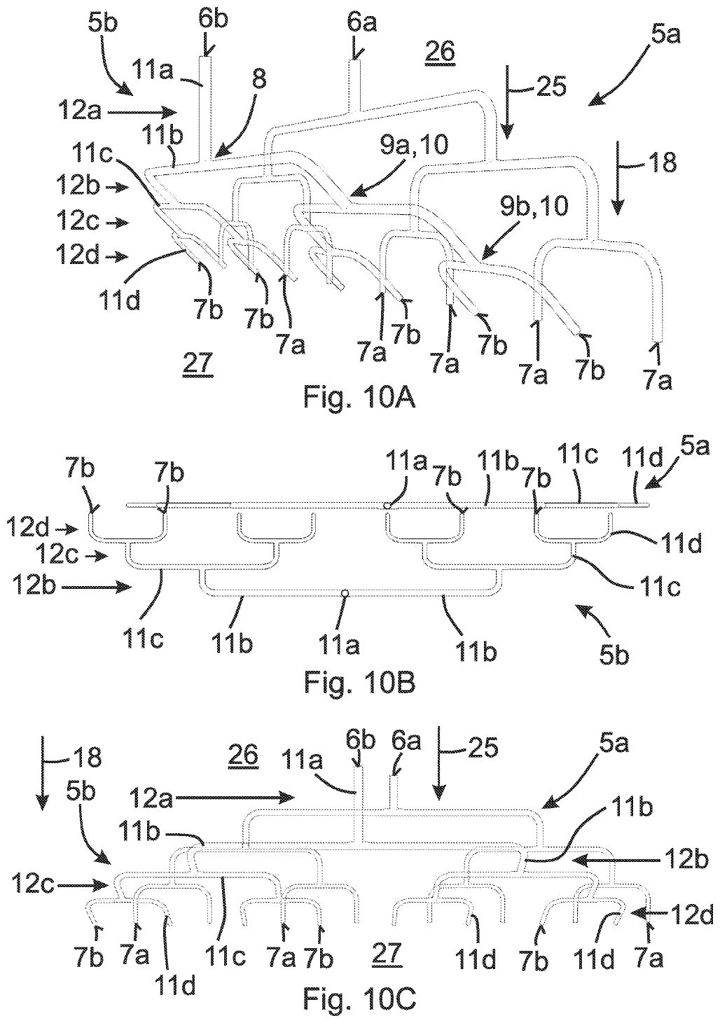

FIG. 10A is a schematic perspective view of a ninth alternative embodiment of the multi-channel system, the melt conductor being embodied as a melt distributor;

FIG. 10B is a schematic top view of the ninth alternative embodiment according to FIG. 10A; and

FIG. 10C is another schematic perspective view of the ninth alternative embodiment according to FIGS. 10A and 10B.

FIG. 1A is a strongly simplified presentation of an extrusion facility 3. The extrusion facility 3 comprises a provision unit 23 adapted to provide and process a polymer melt 24 for manufacturing and processing an extrusion product 30 or an intermediate product. The provision unit 23 is presently the extruder (not presented in detail here) which plasticizes at least one extrudable polymer 29 to form the polymer melt 24. The polymer can be, for instance, a plastic. The provision unit 23 can also be adapted for providing one or more different polymer melts 24 with the same or with different properties. The polymer melt 24 is continuously fed by the provision unit 23 into an extruding die 2, comprising a melt conductor 1 and an extrusion nozzle 14 downstream in the designated direction of flow 25 of the polymer melt 24. The extruding die 2 is integrated in the continuously operating extrusion facility 3 in which the polymer melt 24 is continuously conveyed through the melt conductor 1 in a global machine direction 18, the expressions “downstream” and “upstream” referring to this global machine direction 18.

The melt conductor 1 which in this first example of embodiment is formed as a melt distributor has five separate melt conductor blocks 4a-4e, a multi-channel system 5 extending three-dimensionally inside the melt conductor blocks 4a-4e after assembly of the melt conductor 1. The subdivision of the melt conductor blocks 4a-4e is represented by dashed lines. The melt conductor blocks 4a-4e are manufactured by an additive manufacturing method and arranged stationary with respect to each other and fixed into place. In this manner, a modular structure of the melt conductor 1 is achieved, for the melt conductor blocks 4a-4e can be combined or replaced as desired, depending on requirements on the extrusion product 30 or in case of maintenance or repair. Therefore, the melt conductor blocks 4a-4e can be integrated in the continuously operating extrusion facility 3 as replaceable components of the melt conductor 1. The melt conductor block 4a-4e can be formed massively as a block or delicately with supporting structures. In this case, the multi-channel system 5 is supported by supporting structures arranged spatially around the multi-channel system 5, which are not shown here in detail.

The provision unit 23 is flanged to an input side 26 of the melt conductor 1 or to the first melt conductor block 4a. The second, third, fourth and fifth melt conductor blocks 4b, 4c, 4d, 4e are arranged downstream of the first melt conductor block 4a and have the same width as the first melt conductor block 4a. The extrusion nozzle 14 is flanged to the output side 27 of the melt conductor block 1 or to the second, third, fourth and fifth melt conductor blocks 4a-4e. Alternatively, also the extrusion nozzle 14 can be manufactured with an additive manufacturing method, namely in extrusion nozzle segments—not shown here—which are each integral with one of the second to fifth melt conductor blocks 4b-4e. Downstream, the extrusion nozzle 14 has an extrusion nozzle output 22 which here achieves an atomization of the polymer melt 24 to form the extrusion product 30. The extrusion nozzle 14 has an extrusion nozzle output 22 with a width B of more than 5,000 mm. The width B defines the width of an extrusion product 30 manufactured by the extrusion facility 3, which in FIG. 1A is embodied as a film. Atomization to filaments is possible as well by means of the present extrusion facility 3, in particular by means of the present extruding die 2.

On the output side 27 of the melt conductor 1 a collection chamber 15 is arranged the multi-channel system 5 opens into, the collection chamber 15 being adapted to receive the polymer melt 24 distributed by the melt conductor 1 formed as melt distributor and continuously feed it to the extrusion nozzle 14. Here, in an assembled state of the melt conductor 1, the collection chamber 15 is formed on the output side by the second, third, fourth and fifth melt conductor blocks 4a-4e.

In its entirety, the multi-channel system 5 is only formed during assembly of the melt conductor 1, i.e. with mutual tensioning of the melt conductor blocks 4a-4e. For as can be seen in FIG. 1B in combination with FIG. 1C, the multi-channel system 5 extends through all melt conductor blocks 4a-4e, each of the melt conductor blocks 4a-4e having a partial channel system with a plurality of melt channels 11 which in the assembled state of the melt conductor 1 form the multi-channel system 5. In other words, the melt channels 11 of all melt conductor blocks 4a-4e are fluidically interconnected, forming the multi-channel system 5.

FIG. 1B shows the melt conductor 1 in top view. Mutual tensioning of the melt conductor blocks 4a-4e occurs by means of a tensioning system 13 spatially arranged around the melt conductor 1 or around all melt conductor blocks 4a-4e, which tensioning system mutually tensions the melt conductor blocks 4a-4e to form one block unit. The tensioning system 13 here comprises a retention device 16 with four frame parts 17 which can be thermally activated. A smaller or a larger number of frame parts 17 are conceivable as well, depending on the configuration of the melt conductor blocks 4a-4e. The frame parts 17 to be thermally activated are embodied such that a thermal expansion of the melt conductor blocks 4a-4e during operation, either by the polymer melt 24 conveyed through the multi-channel system and/or by supplementary temperature regulation of the melt conductor 1, achieves a tensioning effect. In this manner, no separate mechanical tensioning of the melt conductor blocks 4a-4e with respect to each other is required, for during operation of the extrusion facility 3, the melt conductor blocks 4a-4e are automatically tensioned with respect to one another. Independently thereof, the tensioning system 13 can nevertheless be adapted for at least partial mechanical tensioning of the melt conductor blocks 4a-4e.

The melt conductor blocks 4a-4e can be embodied and joined as desired. In particular, it is possible to manufacture, in addition to individually embodied melt conductor blocks, standard blocks so as to allow faster manufacture, assembly and allocation of the melt conductor blocks 4a-4e and to produce blocks which are less expensive. Here, the second to fifth melt conductor blocks 4b-4e are identical; in particular the partial channel systems formed in the respective melt conductor blocks 4b-4e are identical. Thus, the melt conductor 1 according to this embodiment has five melt conductor blocks 4a-4e; however, only two different melt conductor blocks 4a-4e are provided. The first melt conductor block 4a pre-distributes the polymer melt 24 to the melt conductor blocks 4b-4e which are downstream in the global machine direction 18 and switched in parallel.

FIG. 1C shows a detailed partial section between the first and the second melt conductor blocks 4a, 4b. Presently, the melt conductor blocks 4a, 4b have positioning means 31 in the form of a projection 37 and a recess 38, the projection 37 during assembly of the melt conductor blocks 4a, 4b protruding into the recess 38, thus preventing a relative movement of the melt conductor blocks 4a, 4b, in this case to the left and to the right on the leaf level. During additive manufacturing of the respective melt conductor block 4a, 4b, the projection 37 is formed integral therewith, the recess being formed as well directly during manufacturing of the respective melt conductor block 4a, 4b. In this manner, the arrangement of the projection 37 and of the recess 38 complementary therewith is predetermined. With the positioning means 31, the melt conductor blocks 4a, 4b can thus be directly positioned with respect to each other during assembly without supplementary orientation and positioning of the melt conductor blocks 4a, 4b being required.

In FIG. 1C, it can be seen that the multi-channel system 5 extends three-dimensionally through at least two of the melt conductor blocks 4a, 4b. The melt conductor blocks 4a, 4b are configured, mutually arranged and tensioned such that a channel output 36 of the melt channel 11 formed on the first melt conductor block 4a is uniquely allocated to the melt channel 11′ formed at the second melt conductor block 4b and vice versa. In other words, the channel input 35 and the channel output 36 have the same shape and size at the point of intersection of the melt channels 11 and 11′ such that unimpeded conveyance of the polymer melt 24 is possible and in particular deposits and/or defects in the polymer melt are prevented.

In addition, seals 34 are provided between a first contact surface 33a of the first melt conductor block 4a and a second contact surface 33b contacting the first contact surface 33a, which achieve a sealing effect of the multichannel system 5 with respect to an outer atmosphere. In addition, the polymer melt 24 is prevented from reacting with air. Here, the seals 34 are received on the first melt conductor block 4a.

The embodiment and arrangement of the seals 34 and the positioning means 31 are to be understood as merely exemplary. The shape, size and arrangement can be selected as desired and can be applied without any problems in particular to all contact surfaces 33a, 33b between the melt conductor blocks 4a-4e which contact each other.

FIG. 2 shows a second alternative embodiment of the melt conductor 1; the output side 27 of the melt conductor 1 is schematically shown. The melt conductor 1 has three melt conductor blocks 4a, 4b, 4c, the second and the third melt conductor block 4b, 4c together being just as wide as the first melt conductor block 4a. Here, the melt conductor 1 is assembled in two layers, the first melt conductor block 4a being arranged in the lower layer and the second and third melt conductor blocks 4b, 4c in the upper layer. It thus becomes clear that the melt conductor blocks 4a, 4b, 4c can be arranged and tensioned both next to each other and on top of each other.

In this embodiment, the melt conductor 1 has means for connection, or threaded connection, respectively, of the melt conductor blocks 4a, 4b, 4c. These means are configured as tie rods 32—shown here in dashed lines—which are guided and screwed through openings 39, shown here in dashed lines as well. By means of the tension rods 32, a tensioning effect is achieved which prevents relative movement of the melt conductor blocks 4a, 4b, 4c. A larger number of tie rods 32 than is shown here is possible as well; in particular, the first and the second melt conductor block 4a, 4b can be tensioned with respect to one another. On the sectional planes between the melt conductor blocks 4a, 4b, 4c an arrangement of seal elements 34 and/or positioning means 31 is possible, in the same way as in FIG. 1C. Alternatively or additionally, the melt conductor blocks 4a, 4b, 4c can after positioning be interconnected by material engagement, in particular by adhesive bonding, soldering, welding or the like.

Here the multi-channel system 5 is configured three-dimensionally such that a plurality of outputs 7 of the multi-channel system 5 are arranged on the output side 27 of the melt conductor 1, the outputs 7 being arranged transversely to the output direction of the designated melt stream, i.e. spaced on several planes or layers on the leaf level. Depending on the requirements on the extrusion product 30, the outputs 7 can be arranged in any configuration with respect to each other and in one or more layers. The outputs 7 are configured to convey the polymer melt 24 into the collection chamber 15 to feed the extrusion nozzle 14 according to FIG. 1A, i.e. to feed the extrusion nozzle 14. The configuration of the multi-channel system 5 according to this example of embodiment is exemplarily described for the first and the second melt conductor block 4a, 4b in FIGS. 7A and 7B and for the third melt conductor block 4c in FIGS. 10A through 10C.

In this example, the outputs 7 are arranged in six parallel layers. For the first two melt conductor blocks 4a, 4b four layers are provided, four outputs 7 each being vertically arranged on top of each other on the leaf level with equal spacing. In contrast, the third melt conductor block 4c has two layers of outputs 7, one output 7 each of one layer being arranged centrally between two outputs 7 of the respective other layer in the direction of flow of the polymer melt 24. Thus, it is possible to arrange outputs 7 transversely to the output direction of the designated melt stream on top of each other, misaligned with respect to each other and/or partly overlapping.

FIG. 3 shows the multi-channel system 5 according to the first embodiment in FIGS. 1A and 1B, where this multi-channel system 5 can be embodied as a partial channel system in one of the second to the fifth melt conductor blocks 4b-4e. By means of the multi-channel system 5, the polymer melt 24 is distributed from an input 6 arranged on an input side 26 of the melt conductor 1 embodied in this case as a melt distributor, via a branching 8, several levels 9a, 9b of sub-branches 10 arranged in series and several fluidically interposed levels of divided melt channels 11 to a plurality of outputs 7 fluidically connected to the input 6 and arranged on the output side 27 of the melt conductor 1. The designated direction 25 of flow of the polymer melt 24 thus is from the input side 26 to the output side 27.

The multi-channel system 5 thus has an input 6 and a plurality of outputs 7 fluidically connected to the input 6. The input 6 on the input side 26 is an input opening through which the polymer melt 24 is fed into the multi-channel system 5. The outputs 7 can therefore be understood as output openings out of which the polymer melt 24 is evenly distributed and fed to the collection chamber 15—not shown here—with a same melt history.

For simplification purposes, the limits between the melt conductor blocks 4a-4e are not shown in FIG. 3 and in the subsequent Figures. Furthermore, the multi-channel system 5 is shown exemplarily and simplified; the multi-channel system 5 here only comprises one branching 8 and two levels 9a, 9b of sub-branches 10, with naturally three or more levels of sub-branches 10 being possible as well. In the designated direction 25 of flow of the polymer melt 24, a melt channel 11a of the a^{th} level 12a is arranged between the input 6 and the branching 8, a b^{th} level 12b of melt channels 11b between the branching 8 and the first level 9a of sub-branches 10 and between the first level 9a of sub-branches 10 and the second level 9b of sub-branches 10, a c^{th} level 12c of melt channels 11c. A d^{th} level 12d of melt channels 11d is also arranged downstream of the second level 9b of sub-branches 10.

FIG. 3 further shows that the number of melt channels 11 increases with each level; that is, one melt channel 11a of the a^{th} level divides into two melt channels 11b of the b^{th} level; the two melt channels 11b of the b^{th} level in turn each divide into two melt channels 11c of the c^{th} level; i.e. in total four melt channels 11c are formed, etcetera. In other words, the number of melt channels 11 doubles from one level to the subsequent level in the direction 25 of flow. Therefore, also the multi-channel system 5 and its individual cavities in the form of melt channels 11, branching 8 and sub-branches 10 are manufactured by the additive manufacturing method. Furthermore, additional cavities can be provided in the form of a collection chamber 15 according to FIG. 1, local expansions or junctions. Also, the cavities can be embodied as distribution or mixing chambers (not shown here) or the like.

In this embodiment, the melt channel 11a of the a^{th} level 12a has a first local cross-section smaller than the second local cross-section of the divided melt channels 11b of the b^{th} level 12b. Every local cross-section of the divided melt channels 11b of the b^{th} level 12b is again larger than the local cross-section of the divided melt channels 11c of the c^{th} level 12c etcetera.

When smaller or larger local cross-sections of the respective melt channel 11 are mentioned, this means that the melt channel 11 has a larger or smaller cross-section, respectively, over at least half the length of the respective melt channel 11, preferably at least ⅔ the length of the respective melt channel 11, preferably at least ¾ the length of the respective melt channel 11.

Here, the melt channel 11a of the a^{th} level 12a is oriented towards the input 6 in the designated direction 25 of flow of the polymer melt 24 and the melt channels 11b of the b^{th} level 12b are oriented towards the output 7 with respect to the melt channel 11b of the b^{th} level 12b. The melt channels 11c of the c^{th} level 12c are oriented towards the input 6 with respect to the melt channels 11d of the d^{th} level 12d, the melt channels 11d of the d^{th} level 12d being oriented towards the output 7 with respect to the melt channels 11 of the a^{th}, b^{th} and c^{th} levels 12a, 12b, 12c. Accordingly, the melt conductor 1 acts as a melt distributor.

In FIG. 4, a third alternative multi-channel system 5 of a third alternative melt conductor 1, which is not shown here, the melt conductor 1 is, in contrast to FIG. 3, arranged in reverse order in the extruding die 2 and the extrusion facility 3 and is consequently embodied as a melt mixer in this alternative example of embodiment. This is due to the fact that the melt conductor 1 has a plurality of inputs 6, eight in this case, on the input side 26 of the melt conductor 1 via which one or up to eight identical or at least partly different polymer melts 24 are combined into an output 7 fluidically connected to the inputs 6 and arranged on the output side 27 of the melt conductor 1. The multi-channel system 5 is formed substantially identical with the embodiment in FIG. 3. The only difference is that the polymer melt 24 is not distributed through the multi-channel system 5 but that up to eight different polymer melts 24 can be combined by means of the multi-channel system 5. The multi-channel system 5 comprises a branching 8, several levels 9a, 9b of sub-branches 10 arranged in series and several levels of divided melt channels 11 arranged between them; however seen against the designated direction 25 of flow of the polymer melt 24, namely from the output side 27 to the input side 26.

In opposition to the designated direction 25 of flow of the polymer melt 24, a melt channel 11a of the a^{th} level 12a is arranged between the respective output 7 and the branching 8; between the branching 8 and the first level 9a of sub-branches 10, a b^{th} level 12b of melt channels 11b, and between the first level 9a of sub-branches 10 and the second level 9b of sub-branches 10, a c^{th} level 12c of melt channels 11c. A d^{th} level 12d of melt channels 11d is also arranged downstream of the second level 9b of sub-branches 10, which channels are fluidically directly connected to the inputs 6. Thus, in the designated direction 25 of flow of the polymer melt 24, the number of melt channels 11 decreases with each level from the inputs 6 to the output 7; that is, every two of the presently eight melt channels 11d of the d^{th} level 12d are combined to one melt channel 11c of the c^{th} level 12c, i.e. in total four melt channels 11c of the c^{th} level 12c. Every two of the four melt channels 11c of the c^{th} level 12c are again combined to one melt channel 11b of the b^{th} level 12b, i.e. in total there are two melt channels 11b of the b^{th} level 12b, and from the two melt channels 11b of the b^{th} level 12b, a melt channel 11a of the a^{th} level is formed which is directly fluidically connected to the output 7.

In reverse order to the embodiment in FIGS. 1A, 1B and 3, the local cross-section of the respective melt channel level increases in the designated direction 25 of flow of the polymer melt 24 with each lower level. The melt channels 11a of the a^{th} level 12a are oriented towards the output 7 in the designated direction 25 of flow of the polymer melt 24 and the melt channels 11b of the b^{th} level 12b are oriented towards the inputs 6 with respect to the melt channels 11a of the a^{th} level 12a. The melt channels 11c of the c^{th} level 12c are oriented towards the output 7 with respect to the melt channels 11d of the d^{th} level 12d, the melt channels 11d of the d^{th} level 12d being oriented towards the inputs 6 with respect to the melt channels 11 of the a^{th}, b^{th} and c^{th} levels 12a, 12b, 12c. Accordingly, the melt conductor 1 acts as a melt mixer.

FIG. 5 shows a fourth alternative multi-channel system of a fourth alternative melt conductor block 4 not shown here. The multi-channel system 5 is formed as a combination of a melt conductor 1 which is partly formed as a melt distributor and partly as a melt mixer. On the input side of the melt conductor 1 or of the multi-channel system 5, respectively, first an input 6 into the multi-channel system 5 is provided, the melt channel 11a of the a^{th} level 12a being separated into a plurality of melt channels 11d of the d^{th} level 12d in analogy to the embodiment in FIG. 3. Further downstream in the designated direction 25 of flow of the polymer melt, starting from the melt channels 11d of the d^{th} level 12d, the melt channels 11 are again combined in a manner analogous to the embodiment in FIG. 4 via melt channels 11c, 11b of the c′^{th} level 12c‘ and of the b’^{th} level 12b′ down to a melt channel 11a of the a′^{th} level 12a′ or down to the output 7, respectively.

In FIG. 6, a fifth alternative multi-channel system 5 of a fifth alternative embodiment is represented, a combination of a melt conductor 1 formed partly as a melt mixer and partly as a melt distributor being shown here. The method of functioning, however, is opposite to the one shown in the embodiment of FIG. 5. On its input side 26, the multi-channel system 5 has several inputs 6, the melt channels 11d of the d^{th} level 12d, which are fluidically directly connected to the inputs 6, being combined along the designated direction 25 of flow of the polymer melt 24, in a manner analogous to the example of embodiment in FIG. 4, from one level to the other up to a melt channel 11a of the a^{th} level 12a. Further downstream, this melt channel 11a of the a^{th} level 12a is divided, in a manner analogous to the embodiment in FIG. 3, from one level to the other via a branching 8, several levels 9a′, 9b′ of sub-branches 10 as well as interposed levels 12b′, 12c′, 12d′ of melt channels 11b, 11c, 11d until a plurality of outputs 7 are arranged on the output side 27 of the melt conductor 1 or the multi-channel system 5, respectively.

The multi-channel system 5 according to the embodiment in FIG. 5 and according to the embodiment in FIG. 6 is not limited to the shape and arrangement described herein. It is also possible to provide upstream or downstream of the respective partial channel system additional portions formed as melt distributors and/or melt mixers which can be embodied and combined as desired. It is of an advantage, however, if the polymer melt 24 always has the same melt history, independently of which melt channels 11 or melt channel sequence it flows through. In case of eight melt channels 11d of the d^{th} level 12d, the polymer melt 24 is therefore divided into a maximum of eight different melt streams. A “same history” of the polymer melt 24 in this connection means that all melt streams of the polymer melt 24 have traversed the same path through the multi-channel system 5 when they arrive at the output(s) 7 of the multi-channel system 5 and have flown through the same number of melt channels, branchings 8 and sub-branches 10.

The embodiments according to FIGS. 7A through 10C, which are described in the following, exclusively refer to melt conductors 1 formed as melt distributors, with the polymer melt 24 in the multi-channel system 5 being distributed from a respective input 6 to a plurality of outputs 7. Thus, the arrangement and numbering of the levels of melt channels 11 as well as of the branchings 8 and levels of sub-branches 10 are analogous to the first embodiment shown in FIG. 3, that is, ascending in the designated direction 25 of flow of the polymer melt 24. Naturally, the following embodiments are also suitable for implementing the melt conductor 1 as a melt mixer or as any combination of melt mixer and melt distributor.

In the embodiments according to FIG. 1A, FIG. 1B and FIG. 3 through FIG. 6, the multi-channel system 5 is in each case substantially formed lying on one plane, the respective input 6 and output 7 as well as all melt channels 11, branchings 8 and sub-branches 10 being consequently arranged on one common plane. Therefore, at least three degrees of freedom are used for forming the multi-channel system 5.

In contrast, a sixth alternative multi-channel system 5 is represented in FIGS. 7A and 7B, the multi-channel system 5 branching out three-dimensionally in space using five degrees of freedom. As clearly shown in FIG. 7B, the melt channels 11 extend in the direction of flow of the polymer melt 24, starting from the input 6 and distributed at least partly downwards, to the left, to the right, into and out of the leaf level. The melt channels 11 fluidically connected to the input 6 thus branch out over the branchings 8 and sub-branches 10 down to the outputs 7 which in the present arrangement are distributed over two substantially parallel planes, the first level 9a of sub-branches 10 being formed such that the melt channels 11c of the c^{th} level 12b substantially extend rotated by 90° with respect to the melt channels 11b of the b^{th} level 12b, such that starting from each melt channel 11c of the c^{th} level, a separate distribution system 29a, 29b, 29c, 29d is formed, such that the first and the second distribution system 29a, 29b as well as the third and the fourth distribution system 29c, 29d are arranged on one plane, the planes being substantially arranged in parallel.

By means of such a melt conductor 1, it is possible in an easy manner to distribute the polymer melt 24 not only evenly in width in a manner analogous to FIG. 3 but also homogeneously in a direction transverse thereto, that is, in height or in depth, depending on the direction of view, so that the polymer melt 24 can exit from the melt conductor block 4a-4e on a comparatively large surface. This is especially suitable for manufacturing filaments or endless filaments and in particular for producing spunbonded fabrics by means of multirow nozzle dies.

Independently of the arrangement of the branching 8 and the sub-branches 10 in relation to the melt channels 11 and their arrangement in three-dimensional space, the local cross-section of the melt channels 11 decreases from one level to the next 12e down to the outputs 7, the melt channels 11 of each level 12a, 12b, 12c, 12d, 12e being always formed symmetrical in all distribution systems 29a, 29b, 29c, 29d and the separated melt streams of the polymer melt 24 having the same melt history.

The outputs 7 of the first and second distribution systems 29a, 29b are thus located on a theoretical first straight line and the outputs 7 of the third and the fourth distribution system 29c, 29d on a theoretical straight second line. Both lines are arranged in parallel to one another so that all melt streams have the same material properties at the respective output 7 due to conveying the same polymer melt 24. Such an arrangement of the outputs 7 along straight, parallel lines is exemplarily shown in FIG. 2, in this case the melt channels 11 on the first and the second melt distributor block 4a, 4b not being distributed over two levels but over four.

In addition, in FIGS. 7A and 7B, a medium channel 20 is arranged inside the melt conductor 1 extending spatially between the melt channels 11 of the multi-channel system 5 and implementing in particular a circulating fluid supply, in this case for temperature control of the polymer melt 24. The medium channel 20 is not fluidically connected to the melt channels 11 of the multi-channel system 5 and causes temperature control of the melt conductor 1 and in particular of the melt conductor blocks 4a-4e during operation of the extrusion facility 3. Furthermore, additional medium channels of any type can be provided which are arranged fluidically separated from the melt channels 11 of the multi-channel system 5 in one or more melt conductor blocks 4a-4e. The additional medium channels can also be embodied as drying shafts which are adapted, for instance, for accommodating an electric line and/or a measuring unit.

In FIGS. 8A through 8D, a seventh alternative multi-channel system 5 is represented, the multi-channel system 5 here branching out three-dimensionally in space using six degrees of freedom. In this embodiment, it is shown that the two melt channels 11b of the b^{th} level partly extend in opposition to a global machine direction 18. The global machine direction 18 leads from the input 6 to the output 7 of a designated melt flow of the polymer melt 24. Each melt channel 11b of the b^{th} level 12b has a local machine direction 19 which can always be the same in the longitudinal direction of the melt channel 11 or which may change in the longitudinal direction of the melt channel 11, depending on the configuration and extension of the respective melt channel 11. It may be of an advantage if the local machine direction 19 extends at least partially against the global machine direction 18. This can especially be seen in FIG. 8A. In the present case, the input 6 and the outputs 7 of the multi-channel system 5 are substantially arranged on a first plane, the melt channels 11b of the b^{th} level 12b extending partly transversely to this first plane such that the first level 9a of sub-branches 10 is arranged on a second plane parallel to the first plane. The attached melt channels 11c of the c^{th} level 12c extend partly on the second plane and are guided back to the first plane for further distribution of the polymer melt 24. By guiding the melt channels 11 three-dimensionally in space, and in particular by guiding the local machine direction 19 of the melt channels 11 partly against the global machine direction 18, the polymer melt 24 is distributed over a smaller axial construction space, that is, in the global machine direction 18 of the melt conductor 1. In this manner, the melt conductor 1 can be constructed to be more compact.

FIG. 9 shows an eighth alternative example of embodiment with an eighth alternative multi-channel system 5. The multi-channel system 5 is substantially identical with the multi-channel system 5 in FIG. 3. The main difference is that the melt conductor 1, here in the area of the melt channels 11c of the c^{th} level 12c, each has a static functional element 21 in the form of a static mixing element for influencing the designated polymer melt 24. The respective functional element 21 is arranged within a local broadening 28 of the melt channels 11c of the c^{th} level 12c and achieves mixing of the polymer melt 24 conducted and distributed within the melt channels 11c of the c^{th} level 12c. In this manner homogenization of the melt strand conducted inside the respective melt channel 11, in particular of its flow and material properties, can be ensured. Thus, the respective functional element 21 is arranged in one of the melt channels 11c of the c^{th} level 12c between a sub-branch 10 of the first level 9a and a sub-branch 10 of the second level 9b. Before and after the local broadening 28, the respective melt channel 11c of the c^{th} level 12c has substantially identical cross-sectional sizes and shapes. Alternatively, the static mixing element can also be arranged directly within the respective melt channel 11 and not in a local broadening.

In a ninth alternative embodiment according to FIGS. 10A through 10C, the melt conductor 1 has a first multi-channel system 5a and a second multi-channel system 5b fluidically separated therefrom, three or more multi-channel systems easily being conceivable as well. A first polymer melt 24 is fed into a first input 6a of the first multi-channel system 5a and a second polymer melt 24 into a second input 6b of the second multi-channel system 5b, where the polymer melts 24 may have the same or different properties. Thus, each multi-channel system 5a, 5b has a respective input 6a, 6b for feeding in the respective polymer melt 24 and a plurality of outputs 7a, 7b for feeding the polymer melt 24 into an extrusion nozzle (not shown here). The first multi-channel system 5a is formed in a manner substantially analogous to the multi-channel system 5 in FIG. 3. We therefore refer to the corresponding description, where for reasons of better clarity, identical reference numbers are not repeated, unless where this is absolutely necessary.

The melt channel 11a of the a^{th} level 12a of the second multi-channel system 5b extends at first, starting from the input 6a of the second multi-channel system 5b, in parallel to the melt channel 11a of the a^{th} level 12a of the first multi-channel system 5a. The melt channels 11b of the b^{th} level 12b, which are downstream of the branching 8, are however rotated by 45°, namely by 45° with respect to the first multi-channel system 5a so that the melt channels 11 of the b^{th}, c^{th} and d^{th} levels 12b, 12c, 12d of the second multi-channel system 5b extend towards the first multi-channel system 5a and with each increasing level continuously approach the melt channels 11 of the first multi-channel system 5a. This results in the outputs 7b of the second multi-channel system 5b to be comparatively close to the outputs 7a of the first multi-channel system 5a so that the melt stream of the polymer melt 24 distributed with the second multi-channel system 5b exits in the region of the outputs 7a, 7b at a comparatively small distance from the melt stream of the polymer melt 24 distributed with the first multi-channel system 5a.

The first outputs 7a of the first multi-channel system 5a are arranged on a first straight line and the second outputs 7b of the second multi-channel system 5b on a second straight line, the lines being substantially parallel to each other. In other words, the outputs 7a, 7b of the respective multi-channel system 5a, 5b are arranged on two parallel planes. In this manner, two-layered film webs can be produced whose layers can have identical or different material properties.

The outputs 7a, 7b of the multi-channel systems 5a, 5b are arranged misaligned with respect to each other transversely to the designated direction 25 of flow or to the global machine direction 18 of the respective polymer melt 24, respectively. Each output 7a of the first multi-channel system 5a is arranged between two outputs 7b of the second multi-channel system 5b. The two multi-channel systems 5a, 5b are arranged spatially misaligned with respect to each other. Such an arrangement of the outputs 7 can be envisaged for the third melt conductor block 4c according to FIG. 2, the melt channels 11 on the third melt conductor block 4c not exiting on two parallel planes from the third melt conductor block 4c.

The two multi-channel system 5a, 5b extend through at least two of the melt conductor blocks 4a-4e in a manner analogous to FIG. 1B and FIG. 1C. We therefore refer to FIG. 1C, where a channel output 36 of a first partial channel system of e.g. the first melt conductor block 4a is uniquely assigned to a channel input 35 of a second partial channel system of e.g. the second melt conductor block 4a. The first multi-channel system 5a is formed at least from the first and the second partial channel system after assembly of the melt conductor 1. Similarly, a channel output 36 of a third partial channel system of e.g. the first melt conductor block 4a is uniquely assigned to a channel input 35 of a fourth partial channel system of e.g. the second melt conductor block 4a. The second multi-channel system 5a is formed from at least the third and the fourth partial channel system after assembly of the melt conductor 1. Of course, this can also be applied to more than two partial channel systems and to the third, fourth and/or fifth melt conductor blocks 4c, 4d, 4e.

At this point, it is explicitly pointed out that features of the solutions described above, in the Claims or in the Figures can also be combined, if desired, so as to cumulatively achieve the features, effects and advantages. It is also explicitly mentioned that the embodiments in FIGS. 1 through 9 can also be implemented with two or more multi-channel systems. For these as well as for the embodiment in FIGS. 10A through 10C, it is also to be said that the melt conductor 1 can also be embodied with three multi-channel systems, with four multi-channel systems, with five or more multi-channel systems.

It is understood that the embodiments explained above are only first embodiments of the invention, in particular of the melt conductor, the extruding die and the extrusion facility according to the invention. Thus, the implementation of the invention is not limited to these embodiments.

All features disclosed in the application documents are claimed as essential to the invention provided that they are novel individually or in combination with respect to the state of the art.

The embodiments shown here are only examples of the present invention and are therefore not to be understood as limiting. Alternative embodiments considered by the person skilled in the art are equally comprised by the scope of protection of the present invention.

### LIST OF REFERENCE NUMBERS

1 melt conductor
2 extruding die
3 extrusion facility
4a first melt conductor block
4b second melt conductor block
4c third melt conductor block
4d fourth melt conductor block
4e fifth melt conductor block
5 multi-channel system
6 input of multi-channel system
7 output of multi-channel system
8 branching
9a first level of a sub-branch
9b second level of a sub-branch
10 sub-branch
11 melt channel
11′ melt channel
11a melt channel to be divided of a first level
11b divided melt channel of a second level
11c divided melt channel of a third level
11d divided melt channel to be divided of a fourth level
11e divided melt channel of a fifth level
12a a^{th} level of a melt channel
12b b^{th} level of a melt channel
12a′ a′^{th} level of a melt channel
12b′ b′^{th} level of a melt channel
12c c^{th} level of a melt channel
12c′ c′^{th} level of a melt channel
12d d^{th} level of a melt channel
12d′ d′^{th} level of a melt channel
12e e^{th} level of a melt channel
13 tensioning system
14 extrusion nozzle
15 collection chamber
16 retention device
17 frame part
18 global machine direction
19 local machine direction
20 medium channel
21 static functional element
22 extrusion nozzle output
23 provision unit
24 polymer melt
25 flow direction of polymer melt
26 input side of melt conductor block
27 output side of melt conductor block
28 local expansion of melt channel
29 polymer
30 extrusion product
31 positioning means
32 tie rod
33a first contact surface of a melt conductor block
33b second contact surface of a melt conductor block
34 seal
35 channel input
36 channel output
37 projection
38 recess
39 through hole
B width of extrusion nozzle output

1. Melt conductor, in particular melt distributor or melt mixer, for an extruding die of an extrusion facility,
comprising two or more melt conductor blocks and a multi-channel system,
the multi-channel system being arranged with three-dimensional extension inside at least one of the melt conductor blocks and having at least one input and at least one output for polymer melt,
where between an input and an output fluidically connected to the input, several branchings arranged in series and several levels of sub-branches are formed over several levels of divided melt channels,
m melt channels of the a^{th} level with x^{th} local cross-sections and n melt channels of the b^{th} level with y^{th} local cross-sections being present,
wherein n>m if b>a,
the yth local cross-sections of the melt channels of the b^{th} level being smaller than the x^{th} local cross-sections of the melt channels of the at level,
and wherein
in the designated direction of flow of the polymer melt, the melt channels of the a^{th} level are oriented towards the input and the melt channels of the b^{th} level towards the output such that the melt conductor acts as a melt distributor for a designated melt stream of the polymer melt,
or
in the designated direction of flow of the polymer melt, the melt channels of the a^{th} level are oriented towards the output and the melt channels of the b^{th} level towards the input, such that the melt conductor acts as a melt mixer for a designated melt stream of the polymer melt.

2. Melt conductor according to claim 1, wherein the multi-channel system extends through at least two of the melt conductor blocks.

3. Melt conductor according to claim 2, characterized by a tensioning system by means of which the melt conductor blocks can be tensioned together to form one block unit.

4. Melt conductor according to claim 3, wherein the tensioning system comprises a retention device with a frame part which can be thermally activated and by means of which at least two of the melt conductor blocks can be tensioned with respect to one another.

5. Melt conductor according to claim 1, wherein the melt conductor blocks have positioning means by means of which the at least two melt conductor blocks can be mutually positioned.

6. Melt conductor according to claim 1, characterized by means for connecting, in particular threading and/or adhesive bonding, the melt conductor blocks.

7. Melt conductor according to claim 6, characterized by a tie rod which is guided through at least two of the melt conductor blocks and tensions at least two of the melt conductor blocks with respect to one another.

8. Melt conductor according to claim 1, wherein a seal is arranged at a contacting surface between two contacting melt conductor blocks.

9. Melt conductor according to claim 1, wherein two or more multi-channel systems extend through at least two melt conductor blocks, a channel output of a k^{th} multi-channel system of the first melt conductor block being uniquely allocated to a channel input of a k^{th} multi-channel system of the second melt conductor block and vice versa.

10. Melt conductor according to claim 1, wherein at least one of the melt conductor blocks has a medium channel, in particular for a circulating fluid supply, especially for temperature control, and/or for an electric line and/or a measuring unit.

11. Melt conductor according to claim 1, wherein at least one of the melt conductor blocks has a static functional element for influencing the designated polymer melt at least indirectly.

12. Melt conductor according to claim 11, wherein the static functional element is a static mixing element.

13. Extruding die for an extrusion facility for manufacturing extrusion products, comprising a melt conductor according to claim 1, the melt conductor being adapted to distribute and/or mix at least one designated polymer melt.

14. Extruding die according to claim 13, characterized by an extrusion nozzle output having a width of more than 5,000 mm, preferably more than 6,000 mm or more than 8,000 mm.

15. Extrusion facility for manufacturing extrusion products, comprising an extruding die according to claim 13.

16. Method of operating an extrusion facility according to claim 15, the extrusion facility being fed with at least one extrudable polymer, in particular at least one plastic, which is plasticized to form a respective polymer melt, the respective polymer melt being fed to the melt conductor, which distributes and/or mixes the respective polymer melt.
